(19) United States
(12) Patent Application Publication
(10) Pub. No.: US 2025/0062896 A1
(43) Pub. Date: Feb. 20, 2025

(54) Integrity and Privacy-Preserving Federated Learning in a Smart Factory Using Smart Contracts and Merkle Tree-Based Key Management

(71) Applicant: University of South Florida, Tampa, FL (US)

(72) Inventors: Zixiang Nie, Tampa, FL (US); Kwang-Cheng Chen, Tampa, FL (US)

(21) Appl. No.: 18/809,169

(22) Filed: Aug. 19, 2024

Related U.S. Application Data
(60) Provisional application No. 63/520,155, filed on Aug. 17, 2023.

(51) Int. Cl. H04L 9/08; H04L 9/00; H04L 9/06

(52) U.S. Cl. CPC H04L 9/0858; H04L 9/0643; H04L 9/50

(57) ABSTRACT

An example system and method that can provide integrity and privacy-preserving communication and integrated operation in smart factory and other IOT applications using smart contracts in blockchain and Merkle Tree-based key management operations. The exemplary Merkle tree-based key management can ensure all communication, control operations, and shared models (e.g., Federated Learning models) are encrypted prior to transmission and sharing with other nodes in the network, with keys being split into parts to each of multiple recipients and later assembled to allow blocking consensus/validation to be performed.

### RELATED APPLICATION

This application claims priority to, and the benefit of, U.S. Provisional Patent Application No. 63/520,155, filed Aug. 17, 2023, entitled, “Integrity and Privacy-Preserving Federated Learning in a Smart Factory Using Smart Contracts and Merkle Tree-Based Key Management” which is incorporated by reference herein in its entirety.

### BACKGROUND

Smart Factory is a concept deriving from IoT that envisages a production environment as a fully automatized and intelligent network of systems that enables facilities, machines, and logistics chains within the manufacturing plant to be managed without human intervention. Industry 4.0 describes the rapid technological advancement in smart manufacturing as a 4th industrial revolution that realizes the digital transformation of the field to deliver real-time decision-making, enhance productivity, and enhance flexibility and agility to revolutionize the way manufacturing and distribution. Smart factory and Industry 4.0 integrate technologies of Cyber-Physical Systems, edge computing, and decentralized, heterogeneous, autonomous Multi-Robot Systems (MRS) for on-demand production with adaptive and resilience productivity and resource efficiency. The decentralization and heterogeneity of MRS allow real-time adjustment of temporal collaboration, production flows, and task execution parameters and further enable flexibility and scalability for time-dynamic production demands.

The field poses challenges for cyber operation integrity, interoperability, and privacy preservation. Incorrect cyber operations of MRS can have a cascading impact on the physical production flows, cause points of failure, and undermine productivity. And, for autonomous collaboration and adaptive performance, heterogeneous MRS requires a unified, reliable and trustworthy automation framework in the cyber domain. Further, information exchanges necessitated by the autonomous collaboration of MRS are considered private and subject to limited access.

There is as benefit to improving privacy, cyber operation integrity, security, and interoperability of smart factory technology and applications.

### SUMMARY

An example system and method are disclosed that can provide integrity and privacy-preserving communication and integrated operation in smart factory and other IoT applications using smart contracts in blockchain and Merkle Tree-based key management operations. In some embodiments, the Merkle tree-based key management system can preserve privacy while applying smart contracts for smart factory types of operations while enforcing integrity within a distributed control operation, including distributed machine learning, e.g., Federated Learning, and the key management for MRS-driven smart factories. In this topology, the shared data in a privacy-preserved and integrity-preserved communication exchange is always encrypted and transmitted with a hash of keys, and the keys are shared among the recipients of the communication in portions such that the whole key is never transmitted in a single communication transmission or by a single actor. In this manner, there is no single point of attack or failure that can compromise the integrity and privacy of the system.

The exemplary Merkle tree-based key management can ensure all communication, control operations, and shared models (e.g., Federated Learning models) are encrypted prior to transmission and sharing with other nodes in the network, with keys being split into parts to each of multiple recipients. Smart contracts seamlessly align with decentralized control operation (e.g., Federated Learning) and enforce the essential steps as well as in Merkle tree-based key management as immutable and accessible transactions within the blockchain. The integration of edge computing, Multi-Robot Systems (MRS), and decentralized machine learning techniques such as Federated Learning can benefit a central AI function and usage in smart factories and Industry 4.0. The flexibility and scalability of MRS and Federated Learning facilitate smart factories that can adapt to dynamic production demands in time-varying environments.

The exemplary system and method can facilitate operations of the physical domain of a smart factory containing multiple dynamic production flows, in which the cyber domain containing edge computing and decentralized robot computing systems are secured from cyber errors or attacks. The exemplary system and method can eliminate or substantially reduce the risk of cyber errors that could exploit flexibility and scalability, exposure confidential information, or even sabotage the productivity and resilience of smart factories.

In an aspect, a non-transitory computer-readable medium is disclosed having instructions stored thereon, wherein execution of the instructions by a processor of an equipment (e.g., robot controller or edge device as a delegated node) of a decentralized, autonomous multi-robot system comprising a plurality of robots and edge nodes causes the processor to: execute control software for a decentralized, autonomous multi-robot system for on-demand production, the system having adaptive and resilience productivity and resource efficiency, each system comprising: a blockchain module comprising smart contracts as a unified automation framework; and a Merkle tree-based key management module for privacy preservation, wherein the key management ensures information exchange in the system is encrypted prior to data exchange and decryption requiring the joint effort of recipients.

In some embodiments, the on-demand production employs a machine learning model trained using Federated Learning (FL) for adaptive production.

In some embodiments, execution of the instructions by the processor of the equipment causes the processor to: execute the Merkle tree-based key management module and the blockchain module; encrypt control or communication data to be shared with a plurality of robots and associated edge nodes as an encrypted message using a key (e.g., wherein the key is generated as a hash of the control or the communication data or (ii) a pseudorandom number); generate, via a hashing operation, (i) a complete key hash as a hash of the key and (ii) a Merkle tree having nodes comprising a plurality of partial key hashes split from the complete key hash; add and transmit, via the blockchain module, as new block of a blockchain, the encrypted message and the complete key hash, wherein the blockchain is distributed to the plurality of robots or associated edge nodes; and transmit (i) the Merkle tree, (ii) a partial key hash of the plurality of partial key hashes, and (iii) a partial key of the plurality of partial keys to each respective node of the plurality of robots or associated edge nodes, wherein each respective node of the plurality of robots or associated edge nodes is configured to (i) receive the transmitted partial key hash as a first local partial key hash and received the partial key, (ii) transmit the first local partial key hash and received partial key to a paired node among the plurality of robots or associated edge nodes, (ii) receive, at least, a second local partial key hash corresponding to the paired node from the paired node and a corresponding partial key of the second local partial key hash, (iii) construct a local complete key hash from the first local partial key hash and, at least, the second local partial key hash, (iv) validate the new block in the blockchain via a smart contract operation of the blockchain if the constructed key hash matches the complete key hash in the new block, and (v) decrypt the control or communication data from the encrypted message using a key generated from (i) the Merkle tree, (ii) the received partial key of the first local partial key hash and, at least, (iii) the received partial key of the second local partial key hash.

In some embodiments, execution of the instructions by the processor of the equipment causes the processor to: execute the Merkle tree-based key management module and the blockchain module; receive, via the blockchain module, a blockchain having a new block comprising an encrypted message and a complete key hash for a message having control or the communication data, wherein the blockchain was distributed to a plurality of robots and associated edge nodes; receive, from a delegated device corresponding to one of the plurality of robots and associated edge nodes, (i) a Merkle tree having nodes comprising a plurality of partial key hashes split from the complete key hash, (ii) a partial key hash of the plurality of partial key hashes, and (iii) a partial key of the plurality of partial keys, receive, at least, from paired node, (i) a second local partial key hash corresponding to the paired node and (ii) a corresponding partial key of the second local partial key hash; construct a local complete key hash from the first local partial key hash and, at least, the second local partial key hash; validate the new block in the blockchain via a smart contract operation of the blockchain if the constructed key hash matches the complete key hash in the new block; and decrypt the control or communication data from the encrypted message using a key generated from (i) the Merkle tree, (ii) the received partial key of the first local partial key hash and, at least, (iii) the received partial key of the second local partial key hash.

In some embodiments, execution of the instructions by the processor of the equipment causes the processor to: execute the Merkle tree-based key management module and the blockchain module; encrypt control or communication data to be shared with a plurality of robots and associated edge nodes as an encrypted message using a key (e.g., wherein the key is generated as a hash of the control or the communication data or (ii) a pseudorandom number); generate, via a hashing operation, (i) a complete key hash as a hash of the key and (ii) a Merkle tree having nodes comprising a plurality of partial key hashes split from the complete key hash; add and transmit, via the blockchain module, as new block of a blockchain, the encrypted message and the complete key hash, wherein the blockchain is distributed to the plurality of robots or associated edge nodes; transmit (i) the Merkle tree, (ii) a partial key hash of the plurality of partial key hashes, and (iii) a partial key of the plurality of partial keys to each respective node of the plurality of robots or associated edge nodes, and transmit a randomized key part-leaf node association, wherein each respective node of the plurality of robots or associated edge nodes is configured to (i) receive the transmitted partial key hash as a first local partial key hash and received the partial key, (ii) receive the randomized key part-leaf node association; (iii) transmit the first local partial key hash and received partial key to a paired node among the plurality of robots or associated edge nodes, (iv) receive, at least, a second local partial key hash corresponding to the paired node from the paired node and a corresponding partial key of the second local partial key hash, (v) construct a local complete key hash from the first local partial key hash and, at least, the second local partial key hash, (vi) validate the new block in the blockchain via a smart contract operation of the blockchain if the constructed key hash matches the complete key hash in the new block, and (v) decrypt the control or communication data from the encrypted message using a key generated from (i) the Merkle tree, (ii) the received partial key of the first local partial key hash, (iii) the receive the randomized key part-leaf node association and, at least, (iv) the received partial key of the second local partial key hash.

In some embodiments, execution of the instructions by the processor of the equipment causes the processor to: execute the Merkle tree-based key management module and the blockchain module; receive, via the blockchain module, a blockchain having a new block comprising an encrypted message and a complete key hash for a message having control or the communication data, wherein the blockchain was distributed to a plurality of robots and associated edge nodes; receive, from a delegated device corresponding to one of the plurality of robots and associated edge nodes, (i) a Merkle tree having nodes comprising a plurality of partial key hashes split from the complete key hash, (ii) a partial key hash of the plurality of partial key hashes, (iii) a randomized key part-leaf node association; and (iv) a partial key of the plurality of partial keys, receive, at least, from paired node, (i) a second local partial key hash corresponding to the paired node and (ii) a corresponding partial key of the second local partial key hash; construct a local complete key hash from the first local partial key hash and, at least, the second local partial key hash; validate the new block in the blockchain via a smart contract operation of the blockchain if the constructed key hash matches the complete key hash in the new block; decrypt the control or communication data from the encrypted message using a key generated from (i) the Merkle tree, (ii) the received partial key of the first local partial key hash, (iii) the received randomized key part-leaf node association, and, at least, (iv) the received partial key of the second local partial key hash.

In some embodiments, the decentralized, autonomous multi-robot system include an edge device configured to control or direct control the equipment and other equipment in a local network, and wherein the edge device is configured to (i) generate a Merkle tree, where the number of leaf nodes aligns with the number of recipients (e.g., M−1+N), (ii) encrypt the updated model, splits the key into parts (e.g., M−1+N parts), (iii) create a randomized key-part-to-leaf-node association, and (iv) transmits a unique set of hashes per recipient along with the key parts and a hash-free Merkle tree topology.

In some embodiments, the equipment serves as an edge node in the decentralized, autonomous multi-robot system, wherein the equipment is configured to control or direct control the equipment and other equipment in a local network, and wherein the edge device is configured to (i) generate a Merkle tree, where the number of leaf nodes aligns with the number of recipients (e.g., M−1+N), (ii) encrypt the updated model, splits the key into parts (e.g., M−1+N parts), (iii) create a randomized key-part-to-leaf-node association, and (iv) transmits a unique set of hashes per recipient along with the key parts and a hash-free Merkle tree topology.

In some embodiments, the equipment is configured to (i) encrypt local data, (ii) split a key of the local data into M parts, (iii) generate a Merkle tree MT with leaf nodes corresponding to number of parts (e.g., M leaf nodes) and a randomized key part-leaf node association, and (iv) transmits the key part-leaf node association to the remaining N−1 robot nodes and the Merkle tree topology to all M edge nodes, wherein all robot nodes transmit the key parts following the received key part leaf node association to all M edge nodes.

In some embodiments, the decentralized, autonomous multi-robot system is heterogenous, wherein the equipment is a first robot of a first type, peer equipment is a second robot of a second type, wherein the first type is the same as the second type.

In some embodiments, the decentralized, autonomous multi-robot system is non-heterogenous, wherein the equipment is a first robot of a first type, peer equipment is a second robot of a second type, wherein the first type is different from the second type (e.g., different manufacturer, different robot model, different robot function).

In some embodiments, the control or communication data is associated with (i) a machine learning model employed in the control or production of the equipment, (ii) a production schedule, (iii) demand forecast, or (iv) task assignment associated with the operation of the equipment.

In some embodiments, execution of the instructions by the processor causes the processor to: train an AI model to be employed in the equipment in the execution of the task, wherein the training is performed by federated learning, wherein the federated learning as a decentralized privacy-preserving operation robots in different spatial locations to simultaneously and collaboratively learn from local data without actually exchanging the local data.

In some embodiments, execution of the instructions by the processor cause the processor to train an AI model to be employed in the equipment in the execution of the task, wherein the training is performed in a one-to-multiple manner for global model distribution and wherein the key management follows a one-to-multiple key-sharing procedure.

In some embodiments, execution of the instructions by the processor causes the processor to train an AI model to be employed in the equipment in the execution of the task, wherein the training is performed in a multiple-to-multiple manner for local model uploading, wherein N nodes upload its respective model to M edge nodes followed by initialization by a delegated robot node.

In some embodiments, the consensus operation employed a Delegated Proof of Work operation.

In some embodiments, the instructions to adjust the parameter of the one or more task parameters provide for real-time adjustment of temporal collaboration, production flows, and/or task execution parameters for the decentralized, autonomous multi-robot system.

In some embodiments, the decentralized, autonomous multi-robot system comprises a manufacturing robot, a warehouse sorting robot, or an autonomous agent executing on a computing device.

In another aspect, a system is disclosed comprising: a processor; and a memory having instructions stored thereon, wherein execution of the instructions causes the processor to: execute control software for a decentralized, autonomous multi-robot system for on-demand production, the system having adaptive and resilience productivity and resource efficiency, each system comprising: a blockchain module comprising smart contracts as a unified automation framework; and a Merkle tree-based key management module for privacy preservation, wherein the key management ensures information exchange in the system is encrypted prior to data exchange and decryption requiring the joint effort of recipients.

In another aspect, a method is disclosed comprising: executing control software for a decentralized, autonomous multi-robot system for on-demand production, the system having adaptive and resilience productivity and resource efficiency, each system comprising: a blockchain module comprising smart contracts as a unified automation framework; and a Merkle tree-based key management module for privacy preservation, wherein the key management ensures information exchange in the system is encrypted prior to data exchange and decryption requiring the joint effort of recipients.

### BRIEF DESCRIPTION OF THE DRAWINGS

The skilled person in the art will understand that the drawings described below are for illustration purposes only.

FIG. 1 shows an example autonomous, heterogeneous, decentralized operating multi-robot system, e.g., in an example smart factory with edge computing or other IoT applications, in accordance with an illustrative embodiment.

FIG. 2 shows an example MRS-driven smart factory comprising a robot having a physical domain and a cyber domain, in accordance with an illustrative embodiment.

FIGS. 3A and 3B show an example exe for the sharer and recipient, respectively, in a one-to-multiple communication using smart contracts in blockchain and Merkle Tree-based key management operations, in accordance with an illustrative embodiment.

FIGS. 3C and 3D show an example method of operation for the sharer and recipient, respectively, in multiple-to-multiple communication using smart contracts in blockchain and Merkle Tree-based key management operations, in accordance with an illustrative embodiment.

FIG. 4A shows an example an example algorithm for the smart contract of an example smart factory's multiple-robot system that executes a round-robin Delegated Proof of Work (DPoW) as a consensus mechanism in accordance with an illustrative embodiment.

FIG. 4B shows an example algorithm for the one-to-multiple key management system in accordance with an illustrative embodiment.

FIG. 4C shows an example algorithm for the multiple-to-multiple key management system, in accordance with an illustrative embodiment.

FIG. 4D shows an example algorithm for smart contracts for performing the transaction for the autonomous, heterogeneous, decentralized operating multi-robot system of FIG. 1 in the blockchain, in accordance with an illustrative embodiment.

FIG. 5A shows an example operation of the method of FIGS. 3A and 3B and the algorithm of FIG. 4B, in accordance with an illustrative embodiment.

FIG. 5B shows an example operation of the method of FIGS. 3C and 3D and the algorithm of FIG. 4C, in accordance with an illustrative embodiment.

FIG. 5C shows a blockchain with smart contracts and DpoW operating in a round-robin style in accordance with an illustrative embodiment.

FIG. 6A shows an example of the Merkle tree that can be generated and distributed, e.g., for the exemplary system and method in accordance with an illustrative embodiment.

FIG. 6B shows an example of the key part-leaf node association that can be generated and distributed, e.g., for the exemplary system and method in accordance with an illustrative embodiment.

FIGS. 6C-6F show examples of messages transmitted as block transactions for a new block being added to a blockchain.

FIGS. 7A-7G show experimental results from a study conducted to develop a blockchain Merkle tree-based key management system. FIG. 7A shows a probability of compromise with different x values and a total number of nodes. FIG. 7B shows results from an experiment environment. FIG. 7C shows a global model distribution having a round-robin style delegation. FIG. 7D shows a local model upload with a delegated robot node, e.g., for multiple-to-multiple data or model sharing. FIG. 7E shows training loss and validation using an example federated learning operation. FIG. 7F overhead data associated with Merkle tree key management module. FIG. 7G shows a model of the message modeled as the Markov process.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference was individually incorporated by reference.

### Example System

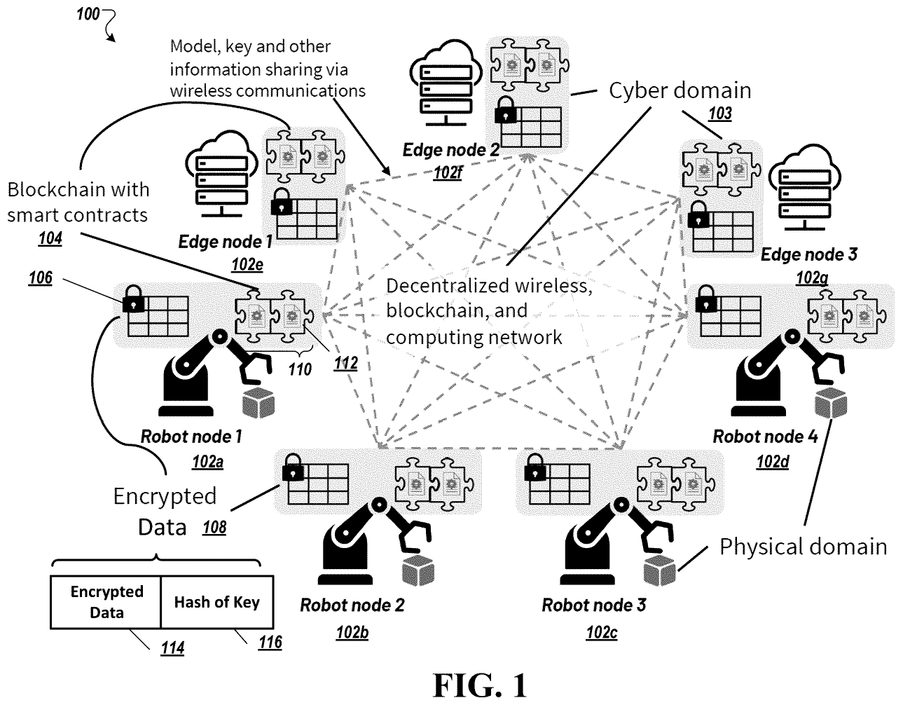

FIG. 1 shows an example autonomous, heterogeneous, decentralized operating multi-robot system 100, e.g., in an example smart factory with edge computing or other IoT applications, in accordance with an illustrative embodiment. The system 100 is configured to provide integrity and privacy-preserving communication and integrated operation using (i) smart contracts in blockchain and (ii) Merkle Tree-based key management operations. The smart contracts can automate information exchanges for its cyber operations and register the information in immutable and accessible transactions within a blockchain. The Merkle tree-based key management operates with the blockchain platform and ensures the information is encrypted prior to the exchange and decrypted using the joint effort of recipients. To this end, two validation operations are performed for a given information exchange in which one validation employs the consensus operation of the blockchain, and the second validation employs a second set of exchanges to confirm the integrity of the consensus operation. The complementary operation thus leverages the immutability of blockchain and smart contracts while mitigating privacy risks introduced by the transparency of smart contracts to provide a resilient smart factory against cyber errors and the cascading impact that can result from such cyber errors.

In the example shown in FIG. 1, the system 100 includes a set of nodes 102 (shown as robot nodes “1” 102a, “2” 102b, “3” 102c, “4” 102d, and edge nodes “1” 102e, “2” 102f, and “3” 102g) in which each node 102 operates a cyber domain 103 comprising blockchain module 104 (shown comprising “Blockchain with smart contracts” 104) and a Merkle tree key management module 106 that encrypts information 108 (shown as “Encrypted data 108) being shared among the nodes 102. While FIG. 1 shows all of the nodes 108 operating using wireless communication, it should be understood that the system 100 can operate in a heterogenous set of devices that include wireless and wired network connection. Wireless communication is susceptible to additional cyber concerns such as snooping, jamming, etc., and is thus shown to demonstrate the enhanced capability of the system to address the additional challenges with a purely wireless system. However, system 100 can be a heterogeneous set of devices that include wireless and wired network connections.

Similarly, the heterogeneity of devices and infrastructure adds additional technical challenges in integration, interoperability, and different availability of resources. While FIG. 1 shows the system comprising heterogeneous nodes, it should be understood that the system 100 can operate in a homogenous set of devices and equipment or clusters of like devices or equipment.

The basis of the privacy-preserving and integrity-preserving communication among the nodes 102 is the blockchain 110 coupled with the Merkle tree key. In FIG. 1, an encrypted data message 108, as a privacy-preserving communication, is transmitted through the blockchain 110 as a blockchain block 112. Integrity in this context refers to the communication being wholesome and unimpaired by others or having the condition of being complete and pure. Privacy in this context refers to the communication among the desired nodes being free from unwanted or undue disturbance from external devices.

When privacy-preserving and integrity-preserving communication is desired, a node 102 (i.e., sharing node) having the information to be shared would encrypt the information and add, as a new block 112 in a blockchain 110, the encrypted information 114 along with a hash string 116 (unencrypted) of the key 118 used to encrypt the information. The blockchain operation is managed by smart contracts, as a computer program or a transaction protocol, that automatically execute and control the consensus operation that ensures a consistent state of the distributed decentralized blockchain among its nodes.

The sharing node 102, e.g., via the smart contracts, would split the key into multiple parts and separately transmit a respective part of the key to a respective node (i.e., a recipient node) along with the Merkle tree root that defines how the keys can be assembled to generate the hash string 116. To this end, each recipient node receives a unique part of the key from the sharing node, and none of the recipient nodes have the complete information to decrypt the encrypted information in the new block of the blockchain. The recipient nodes 102 then would share, e.g., via the smart contracts, their respective partial keys among themselves; this second set of exchanges allows each recipient to recreate, e.g., via the smart contract, the hash 116 in the new block 112 to verify the communication was not snooped or modified, i.e., privacy preserved and integrity-preserved. Once verification is completed by the blockchain, e.g., via Proof of work, the new block is joined to the blockchain, to which the blockchain is then ready to accept another block. Unverifiable blocks or blocks that failed verification are excluded from being joined to the blockchain. Additionally, recipient nodes that share a partial key to which a hash of the partial key does not match the shared Merkle tree root could be readily identified, e.g., as a malfunctioning or malicious actor or device.

In this topology, the exchange is always encrypted and is never transmitted unencrypted, and the whole key is never transmitted in a single communication transmission or by a single actor. In this manner, there is no single point of attack or failure that can compromise the integrity and privacy of the system.

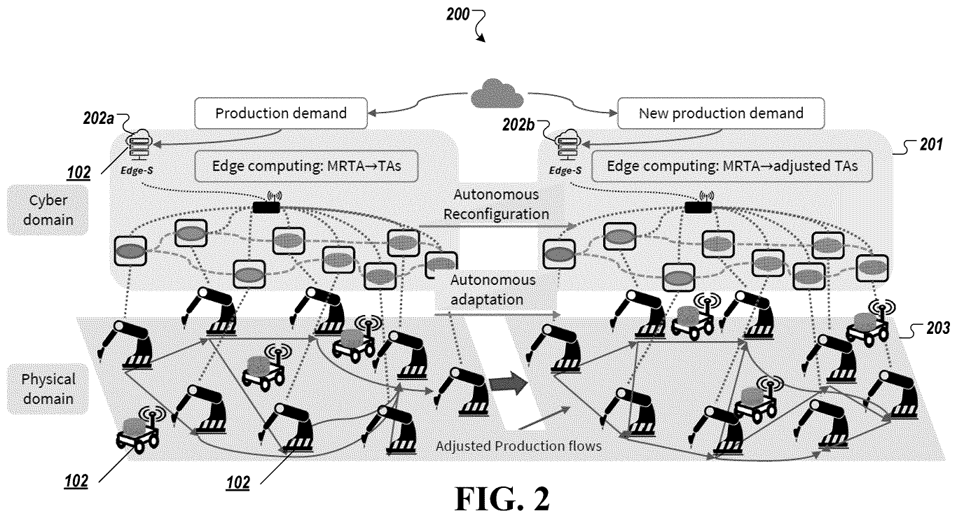

Heterogeneous, decentralized operating multi-robot system (MRS) automated by smart contracts. FIG. 2 shows an example MRS-driven smart factory 200 comprising a robot (e.g., 102) having a physical domain 201 and a cyber domain 203. In the smart factory production flow, the robots (e.g., 102) are collaborating in which one robot performs a first set of one or more tasks on a part that it then can pass to a second robot to perform a second set of one or more tasks, and so on, in a production flow. Indeed, failure or sabotage to one of the robots could then disrupt the entire flow. The exemplary system employs smart contracts to ensure every robot action is performed as a transaction in a blockchain.

The MRS-driven smart factory can be modeled as a Cyber-Physical System (CPS) with edge computing and decentralized robot Artificial Intelligent (AI) computing. The decentralization operation of the multi-robot system can be made to align with the blockchain module, key management module, and smart contracts to provide operation having integrity, interoperability, and privacy. Examples of such systems can be found in [1], [3], [4], [23]. In FIG. 2, edge servers 202 (shown as “Edge-S” 202a, 202b) can compute time-varying Multi-Robot Task Allocation (MRTA) according to the time-varying production demands to provide on-demand production. On-demand production is a heightened standard for production in which products are only manufactured when needed and in quantities required. Of course, the exemplary system (e.g., 100, 200) can produce in other quantities and production flow.

In the example of an on-demand production system, upon receiving the tasks, each robot (e.g., 402), stationary or mobile, physical or virtual, is configured to autonomously collect local data by sensors (e.g., onboard sensors), exchange the collected information with peer robots (e.g., 402) and adjust task execution parameters, e.g., time allocation (TA), for the actuators based on the collected information. The robot and/or associated controllers can include ML models and AI algorithms that can operate in real-time to optimize productivity and energy efficiency and provide resilience operation.

The scalability and resilience requirements of smart factories necessitate the decentralization of the multi-robot system that can operate with autonomous, real-time adjustment of temporal collaboration, production flows, and task execution parameters. Such real-time adjustment of temporal collaboration, production flows, and task execution parameters can then provide flexibility and scalability for time-dynamic production demands. Indeed, the cyber domain operations of the multiple robots impact the physical domain production flows in a smart factory.

Blockchain technology has been considered for smart factories to provide decentralized or distributed recording of manufacturing with immutability and transparency, as well as new automation mechanisms powered by smart contracts [24]. A blockchain network is a decentralized network of computers that share a storage (or database, ledger) of transactions [25]. Particularly, a blockchain network in a smart factory is a fully connected network where all M edge nodes and N robot nodes have a copy of the same blockchain. In the blockchain module, smart contracts are self-executing contracts (i.e., control operations or rules) written into computer-readable code that bring programmability and automation to blockchain [26]. Blockchain networks utilize decentralization for transparency, availability, and immutability for the operation of MRS-driven smart factories, while smart contracts supply automation, trust, integrity, and interoperability. The technologies underpinning blockchain include cryptographic hash functions [27], a peer-to-peer (P2P) network structure [28], and consensus mechanisms [29]. Cryptographic hash functions process an input message to compute a fixed-length byte string, termed a hash. This hash acts as a “digest” of the input message, remaining consistent for identical inputs while exhibiting drastic alterations upon minor modifications to the input. Moreover, the re-engineering of the original input message from its corresponding hash is computationally prohibitive, making hashes crucial for data integrity. An example hash function is the 256-bit Secure Hash Algorithm (SHA-256) employed in numerous blockchain implementations. Blockchain adopts a P2P network structure, constituting a fully interconnected topology among participant edge nodes and robot nodes. Every node in the network concurrently performs as both a server and client, all possessing equal authority and the capability to independently add and validate transactions and blocks.

The legitimacy of transactions and blocks relies on a consensus mechanism among all participating nodes, e.g., Proof of Work or Proof-of-Stake. In the Proof of Work (PoW) [30] consensus mechanism, the node generating a new block to the blockchain, or a designated node, must solve a complex mathematical problem. The block is appended to the blockchain only after all other nodes in the network validate the solution to the problem. As the problem is designed to be computationally challenging to solve yet straightforward to verify, the computation overhead is scalable. Blockchain technology provides transparency and availability through its inherent structure and operation. All participating nodes in the blockchain network have identical blockchain databases except for unconfirmed transactions all the time, which ensures that all the nodes have access to the same information stored in the blockchain without centralized authorization. Also, implementations of blockchain involve relevant details such as timestamps, transaction amounts, and participating nodes' identification (IP addresses or other IDs), enabling effortless tracking and validations.

Blockchain's immutability is facilitated by cryptographic hash functions, while block validity is ensured through consensus mechanisms. Cryptographic hash functions play vital roles in cybersecurity, serving numerous applications, including data integrity validations, password storage, digital signatures, and blockchain technology, among others [31]. A hash function, represented as H=fₕₐₛₕ(message), inputs a message and conducts a one-way computation that outputs a deterministic, fixed hash, typically through bitwise operations, modular arithmetic, and logical functions. Proof of Work (PoW) mandates that participating nodes (also known as miners) carry out computational work, such as solving a complex mathematical problem, to authenticate and append new blocks of transactions to the blockchain. Consequently, once a transaction or block is appended and validated by the network, it transforms into a permanent and immutable record, thereby conferring the blockchain its inherent characteristic of immutability. Meanwhile, particularly in private and public-permissioned blockchains used in industrial contexts, the variation of PoW, such as Practical Byzantine Fault Tolerance (PBFT) and Raft, is adopted to reduce the computational demand and enhance scalability.

Moreover, smart contracts, as programmed by dedicated programming languages such as Solidity for Ethereum may also be programmed by a wide range of programming languages, including C#, Python, and Java, supported by many Turing-complete blockchains such as Neo Blockchain. These contract terms and conditions may be activated by elements in the blockchain, and their execution is ensured by transactions and blocks within the blockchain. Once deployed, smart contracts automatically execute according to predefined codes and upon the fulfillment of certain conditions, thereby facilitating automation in the cyber domain of smart factories, including onboard sensor data collection, data exchange with peer robots, ML, FL, and AI algorithm workflows. This capacity promotes interoperability among distinct robots from various manufacturers. Transactions and blocks enforced by smart contracts bring about trust and integrity, as they provide a transparent and immutable record of all contract-related events under specified terms. In addition, smart contracts may function as protocols defining the interaction among robots, such as data.

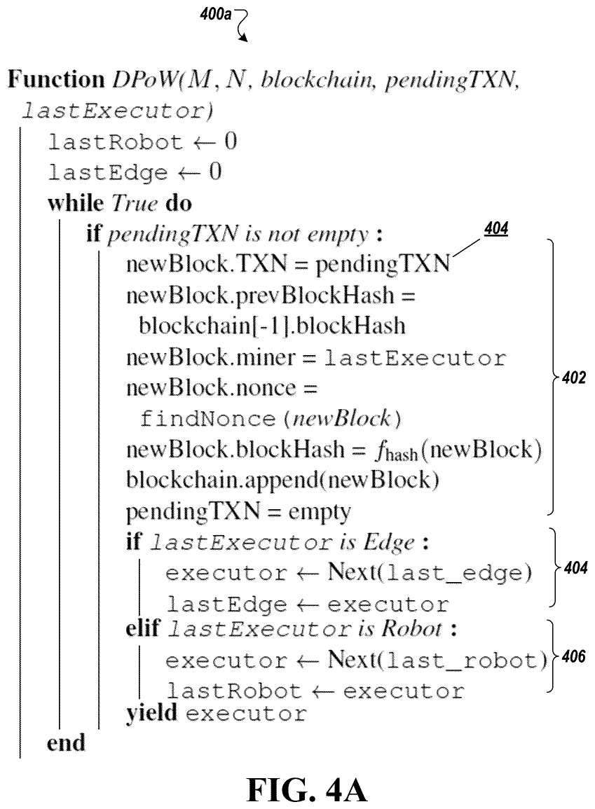

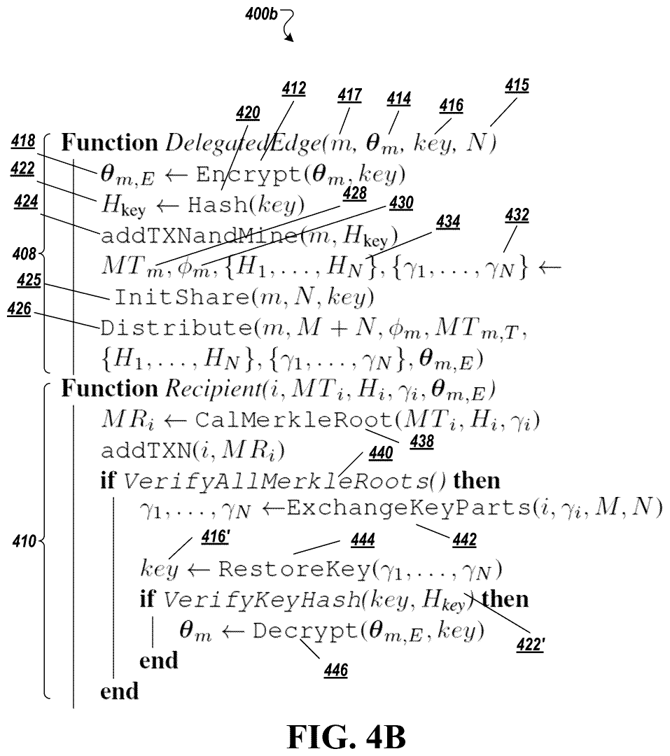

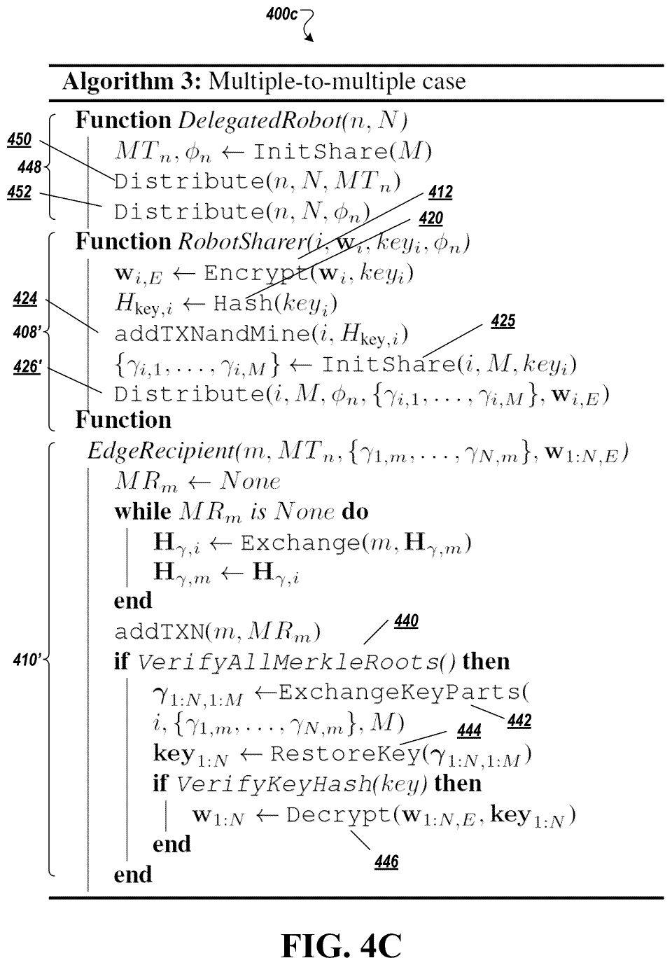

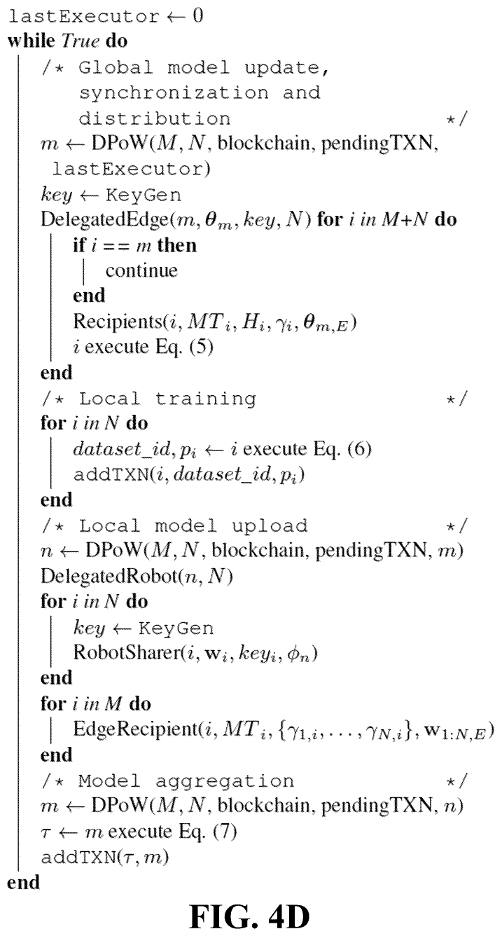

FIG. 4A shows an example an example algorithm 400a for the smart contract of an example smart factory's multiple-robot system that executes a round-robin Delegated Proof of Work (DPOW) as a consensus mechanism. The round-robin DPOW can reduce computational demand and thereby enhance scalability. The delegation process can be both conducted and ensured via a smart contract. The addition of new blocks to the blockchain also referred to as the mining process, can be triggered by the cyber operations and executed by one or more delegated nodes.

In FIG. 4A, the algorithm 400a includes, for a given communication, adding/inserting (402) the communication (shown as pendingTXN) as a new block. The operation includes authentication, confirming the node that will perform the consensus operation.

The consensus operation is performed (404) for the edge devices and then performed (406) for the robot nodes.

### Merkle Tree-Based Key Management System

Privacy preservation necessitates encryption of data and models, and integrity necessitates the validation of all edges and robots' cyber operations. The Merkle tree-based key management module of the exemplary system allows each recipient node to authenticate the legitimacy of the key received from all the other recipient nodes to handle unauthorized access or sniffing of the communication. Furthermore, the algorithmic integrity of cyber operations via blockchain can be expanded to include the integrity of the key management process. The smart contracts can serve as a unified automation mechanism among edges and heterogeneous robots, facilitating the correct execution of key management steps.

The exemplary key management system provides the transmission of all communication, control operations, or models (e.g., ML models) after post-encryption and concurrently facilitates the transmission of encryption key parts to multiple recipients as a transaction in a blockchain. Within the framework of the exemplary system, a received blockchain having a new transaction corresponding to a new communication, control operations, or models may only be decrypted after (i) each recipient verifies the authenticity of key parts from all other recipients, (ii) followed by exchanging of key parts, and (iii) then combining the key parts to be used for the decryption. This operation can deter or enable the real-time detection of cyber errors induced by straightforward wireless sniffing, model inversion attacks, and Sybil attacks. Additionally, in instances where the blockchain cannot be verified or authenticated, the new transaction would be ignored, and the prior blockchain would be used. Notification and detection can be additionally performed.

Given the transparent characteristic of a blockchain, data, and model, when transmitted in a block of the blockchain, are encrypted to preserve privacy against data and model inversion attacks and communication sniffing for the resilience of MRS. However, distributing the keys to the encrypted ML model without compromising the privacy of the keys and the model is a challenging task. The exemplary Merkle tree-based key management system addresses such a challenge based on Shamir's Secret Sharing techniques [33], e.g., using a strong symmetric encryption algorithm such as 256-bit AES encryption [34] or other encryption models that require a large amount of computing power to break. Then, with each data exchange or model encrypted by the unique key, each key is split into multiple key parts, and the entire key can only be recovered through wireless sniffing or brute-force attacks.

A Merkle tree, also known as a hash tree, has the data structure of binary trees, while the hashes are stored as data [35]. In a typical Merkle tree, each leaf node stores a hash of a data block, while each non-leaf node stores a hash of the two hashes of its two child nodes. The root node of the tree, also known as Merkle root, stores a hash of all the leaf nodes. Hash functions can validate the legitimacy of all the data blocks in the exemplary system by providing one-way, deterministic hash outputs in which any changes in data blocks can lead to changes in all the hashes in the Merkle tree, as well as the Merkle root.

The keys to the encrypted data exchange or models in the exemplary system are secrets, and each key is split into multiple key parts (Bytes or even bits) and then distributed among the recipients. The number of parts may equal the number of recipient nodes. The Merkle tree-based key management module executing at each of the recipient nodes can take all the key parts (separately sent from the other recipients) as data blocks to populate the tree or to generate tree root so that only when all the key parts are legitimate, the populated Merkle tree or locally-generated Merkle root is correct, i.e., equal to the Merkle root calculated by the secret sharer. Two types of communication are common for large, decentralized networks: one-to-multiple communication and multiple-to-multiple communication.

Any leakage of the Merkle proof may reveal the tree path and lead to the inference of the data blocks, which is a potential privacy risk. In the exemplary key management system, the Merkle proof should be shared with the designated node and registered by the smart contacts. In both cases, either the key part-leaf node association or the Merkle tree paths are shared with the recipients to control this risk.

### Example Method of Operation-One-to-Multiple Communication Exchange

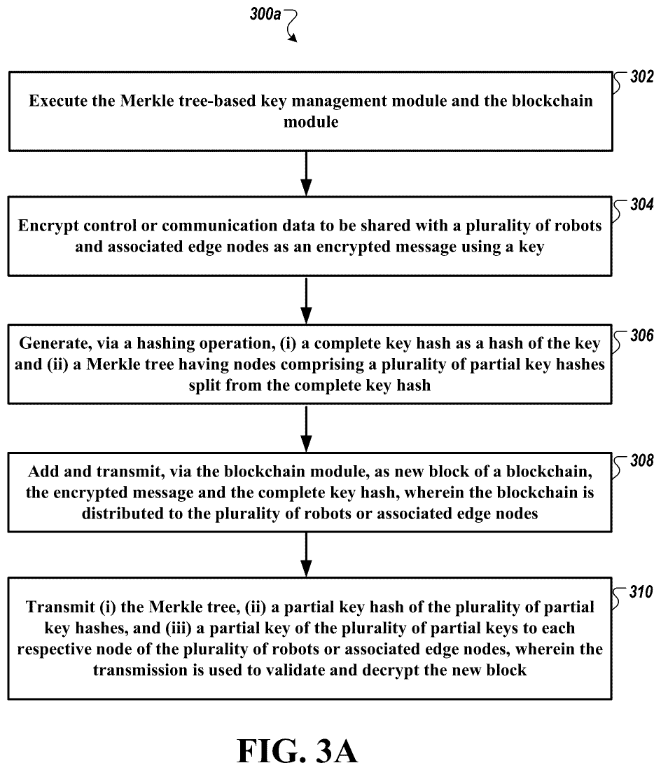

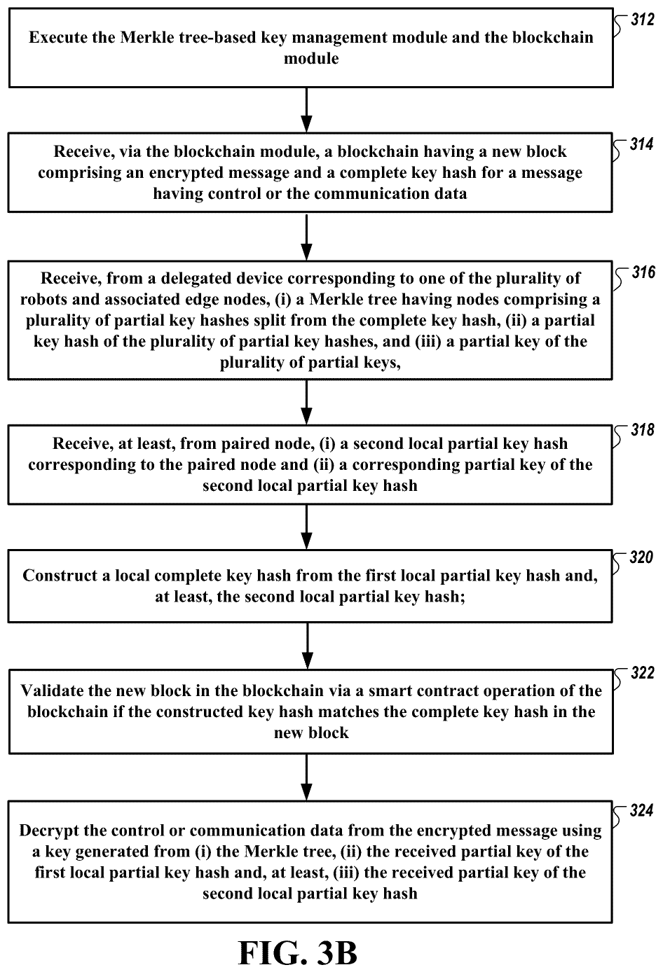

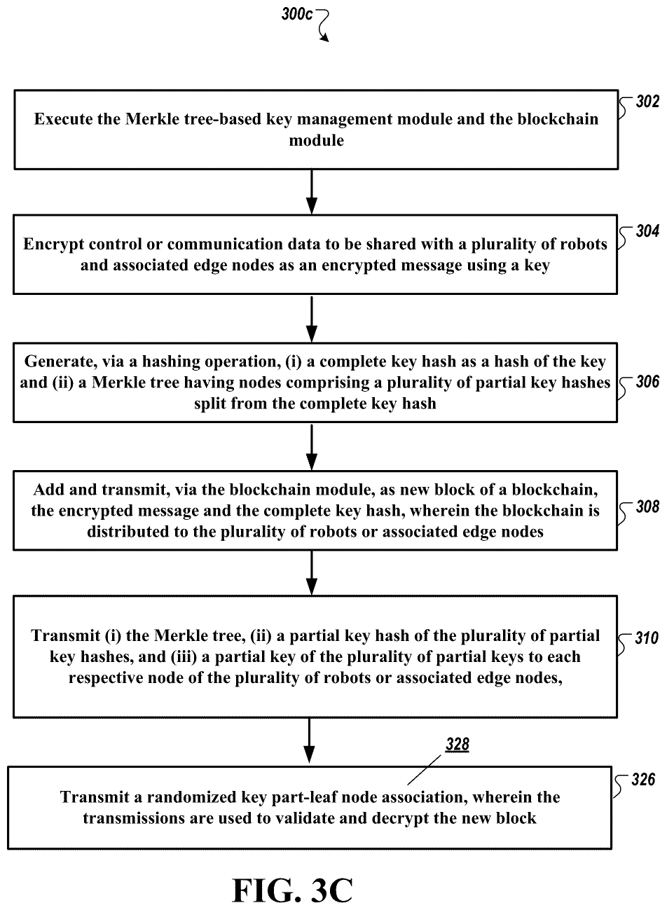

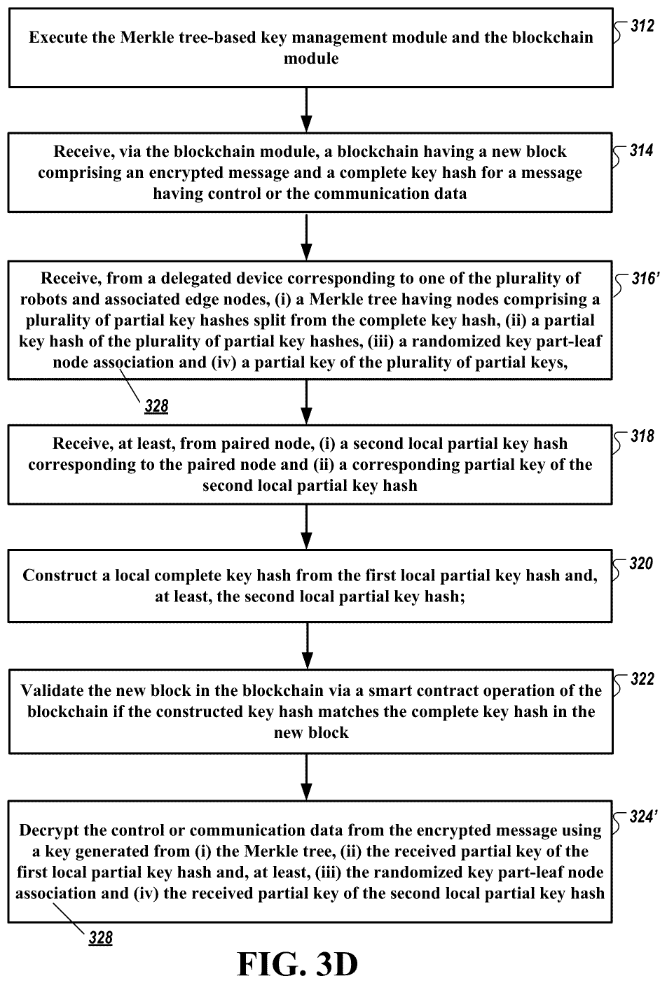

FIGS. 3A and 3B show an example method 300 (shown as 300a, 300b) of operation for the sharer and recipient, respectively, in a one-to-multiple communication using smart contracts in blockchain and Merkle Tree-based key management operations. A one-to-multiple communication exchange can be used for global data or model distribution. The data can be shared by a robot or an edge node as the sharing node. In the use case of an edge node, the sharing edge node can share the data or data updates (e.g., global model for machine learning or federated learning) with all M−1 edge nodes and N robot nodes.

Sharer Operation. FIG. 3A shows the method 300a from the perspective of a single sharer in a one-to-many configuration. FIG. 4B shows an example algorithm 400b for the one-to-multiple key management system. The DelegatedEdge function 408 shows the operation performed by the sharer device, e.g., as described in relation to FIG. 3A.

In the case that one node shares an ML model with multiple nodes, such as the global model distribution in FL, the key management follows a one-to-multiple key-sharing procedure. The delegated edge node formulates a Merkle tree MT, where the number of leaf nodes aligns with the number of recipients (M−1+N), i.e., all other edge nodes and all robot nodes. Subsequently, the edge node encrypts the updated model, splits the key into M−1+N parts, and creates a randomized key-part-to-leaf-node association ¢. @ is a Bipartite graph with each vertex from the recipient set being connected to exactly one vertex from the leaf-node set. In FIG. 3A, method 300a includes executing (302) a Merkle tree-based key management module and the blockchain module.

With all the key parts (Y) serving as data, the edge node computes the hashes of each non-leaf node, including the Merkle root. Simultaneously, the edge node transmits the necessary hashes-a unique set per recipient-along with the key parts and a hash-free Merkle tree topology. This step obfuscates the key part-leaf node association from the recipients, implying that recipients must possess three valid pieces of information (key parts, Merkle tree topology, and necessary hashes) to calculate the Merkle root. Furthermore, the delegated edge node adds a transaction containing the key's hash to the blockchain, an action regulated by smart contracts. This enables recipients to validate the combined key in subsequent steps.

For the recipients, they utilize the received Merkle tree topology, along with their unique key part and set of hashes, to compute the Merkle root. Subsequently, they record these calculated Merkle roots as transactions to the blockchain, an operation ensured by smart contracts. Given that all the Merkle roots should coincide with the one calculated by the sharer edge node, nodes possessing an incorrect or fabricated key part will be instantly detected and identified. Following this, the recipients interchange their key parts, combine them to authenticate the hash originating from the delegated node, and then decrypt the encrypted model.

In the example shown in FIG. 4B, the delegate Edge function 408 employs the data or model portion 414 to be exchanged, a key 416 for the encryption, the number or the list of recipients N 415, and an identifier of the sharer node m 417. The key 416 can be based on the data 414 or is a pseudorandom-generated number.

In the example shown in FIG. 3A, Method 300a includes encrypting (304) control or communication data to be shared with a plurality of robots and associated edge nodes as an encrypted message using a key (e.g., wherein the key is generated as a hash of the control or the communication data or (ii) a pseudorandom number). An example of encrypting operation 304 of FIG. 3A is shown as function 412 in FIG. 4B using data or model portion θₘ 414 and a key 416 to generate encrypted data θ_{m,E} 418. An example of encryption is the SHA-256.

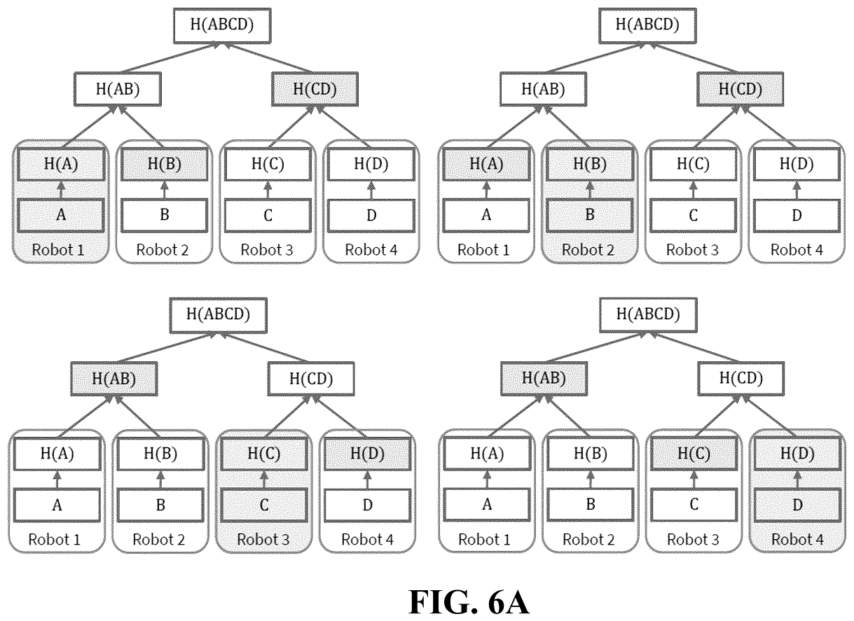

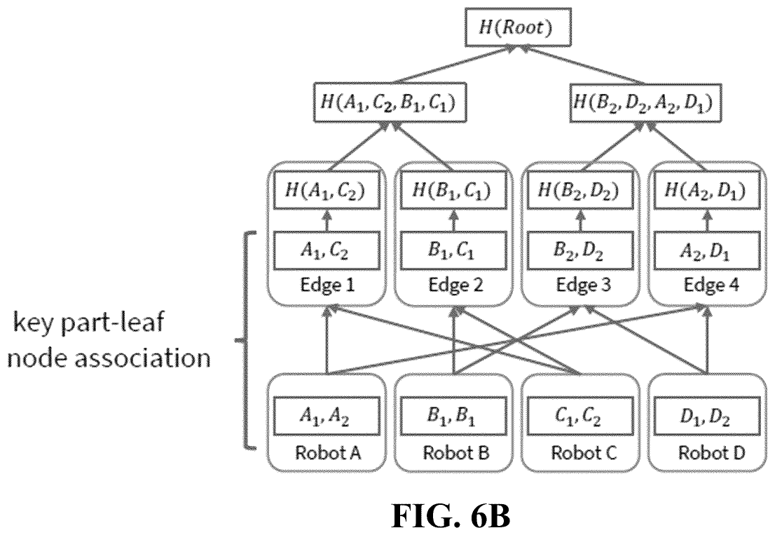

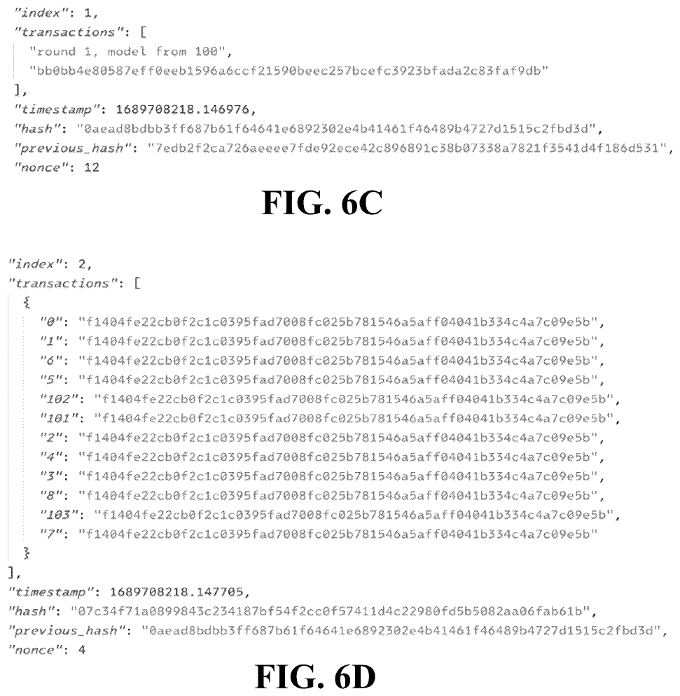

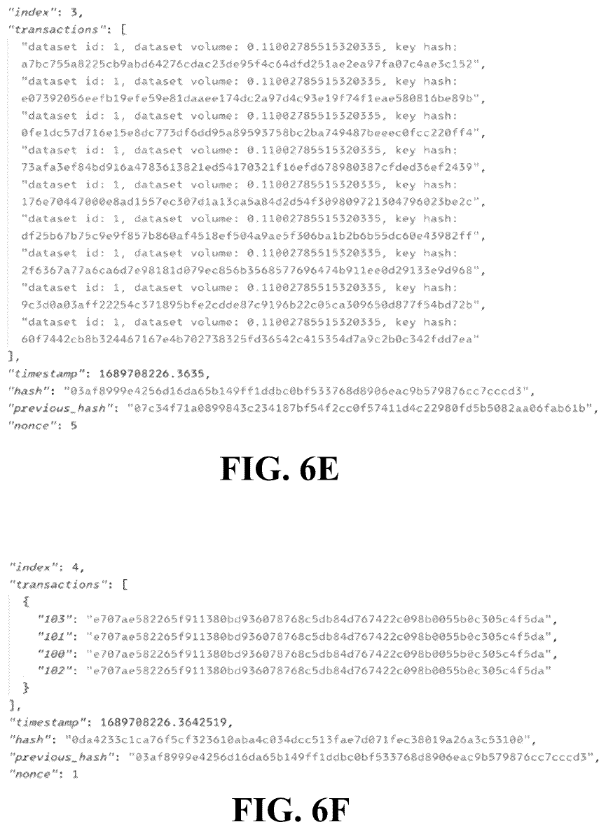

Method 300a then includes generating (306), via a hashing operation, (i) a complete key hash as a hash of the key and (ii) a Merkle tree having nodes comprising a plurality of partial key hashes split from the complete key hash. An example of the hashing operation 304 of FIG. 3A is shown as function 420 in FIG. 4B using the key 416 to generate the complete key hash H_{key} 422. In an example, the hash function 420 maps the key 416 of a fixed-size value, e.g., 14 bytes (112 bits). In some embodiments, the length of the hash values is 10, 11, 12, 13, 14, 15, 16, 17, 18, 19, 20 bytes. In some embodiments, the length of the hash values is longer than 20 bytes but less than the length of the key. An example of the Merkle tree is shown in FIG. 6A.

Method 300a then includes adding and transmitting (308), via the blockchain module, as a new block of a blockchain, the encrypted message, and the complete key hash, wherein the blockchain is distributed to the plurality of robots or associated edge nodes. An example of the blockchain operation 308 to add a new block of FIG. 3A is shown as function addTXNandMine 424 in FIG. 4B for the sharer node 417 using the complete key hash H_{key} 422. The initShare function 425 creates, for the sharer m from the complete key hash H_{key} 422 and the number of recipients N, a MerkleTree MTₘ 428, key part-leaf node association ϕₘ 430, key parts {γ₁, . . . , γ_{N}} 432, and corresponding partial hash of the key parts {H₁, . . . , H_{N}} 434.

Method 300a then includes transmitting (310) (i) the Merkle tree, (ii) a partial key hash of the plurality of partial key hashes, and (iii) a partial key of the plurality of partial keys to each respective node of the plurality of robots or associated edge nodes. An example of the distribution operation 310 of FIG. 3A is shown as function Distribute 426 that transmits from sharer node m to the recipient nodes M+N, the new blockchain block having the Merkle tree MTₘ 428, the key part-leaf node association ϕₘ 430, key parts {γ₁, . . . , γ_{N}} 432 and corresponding partial hash of the key parts {H₁, . . . , H_{N}} 434, the encrypted data θ_{m,E} 418.

Each respective node of the plurality of robots or associated edge nodes is configured to (i) receive the transmitted partial key hash as a first local partial key hash and received the partial key, (ii) transmit the first local partial key hash and received partial key to a paired node among the plurality of robots or associated edge nodes, (ii) receive, at least, a second local partial key hash corresponding to the paired node from the paired node and a corresponding partial key of the second local partial key hash, (iii) construct a local complete key hash from the first local partial key hash and, at least, the second local partial key hash, (iv) validate the new block in the blockchain via a smart contract operation of the blockchain if the constructed key hash matches the complete key hash in the new block, and (v) decrypt the control or communication data from the encrypted message using a key generated from (i) the Merkle tree, (ii) the received partial key of the first local partial key hash and, at least, (iii) the received partial key of the second local partial key hash.

Recipient Operation. FIG. 3B shows the method 300b from the perspective of a single recipient in a one-to-many configuration. The Recipient function 410 shows the operation performed by the recipient devices, e.g., as described in relation to FIG. 3B.

In FIG. 3B, the method 300b includes executing (312) at a recipient node that received a communication exchange or message from a sharer node, the Merkle tree-based key management module, and the blockchain module.

Method 300b then includes receiving (314), via the blockchain module, a blockchain having a new block comprising an encrypted message and a complete key hash for a message having control or the communication data, wherein the blockchain was distributed to a plurality of robots and associated edge nodes. Method 300b then includes receiving (316), from a delegated device corresponding to one of the plurality of robots and associated edge nodes, (i) a Merkle tree having nodes comprising a plurality of partial key hashes split from the complete key hash, (ii) a partial key hash of the plurality of partial key hashes, and (iii) a partial key of the plurality of partial keys. In the example shown in FIG. 4B via Recipient function 410, the recipient i receives the Merkle tree MTᵢ, the partial hash Hᵢ, the partial key γ₁, and the encrypted data θ_{m,E} 418. In FIG. 4B, the Recipient function 410 also performs an initial verification of the key and key hash by calculating via the CalMerkleRoot function 438 using the received Merkle tree MTᵢ, the partial hash Hᵢ, and the partial key γ₁ and comparing them via function addTXN.

Method 300b then includes receiving (318), at least, from a paired node, (i) a second local partial key hash corresponding to the paired node, and (ii) a corresponding partial key of the second local partial key hash. In the example shown in FIG. 4B, the Recipient function 410 performs a VerifyAllMerkleRoots( ) function 440 that exchanges the local partial key hash from the recipients. Upon a successful Merkle tree root validation, the key can be exchanged.

Method 300b then includes constructing (320) a local complete key hash from the first local partial key hash and, at least, the second local partial key hash. In the example shown in FIG. 4B, the Recipient function 410 performs an ExchangeKeyParts function 442 to send its local partial key γ₁ and receive from the N recipients the key parts {γ₁, . . . , γ_{N}} 432.

Method 300b then includes validating (322) the new block in the blockchain via a smart contract operation of the blockchain if the constructed key hash matches the complete key hash in the new block. In the example shown in FIG. 4B, the Recipient function 410 performs the RestoreKey function 444 that combines the key parts {γ₁, . . . , γ_{N}} 432 into the key 416 and then performs a VerifyKeyHash function 446 using the complete key 416′ and the complete key hash 422′.

Method 300b then includes decrypting (324) the control or communication data from the encrypted message using a key generated from (i) the Merkle tree, (ii) the received partial key of the first local partial key hash and, at least, (iii) the received partial key of the second local partial key hash. In the example shown in FIG. 4B, the Recipient function 410 performs a Decrypt function 446 using the encrypted data θ_{m,E} 418 and completed key 416′ to generate the decrypted data θₘ.

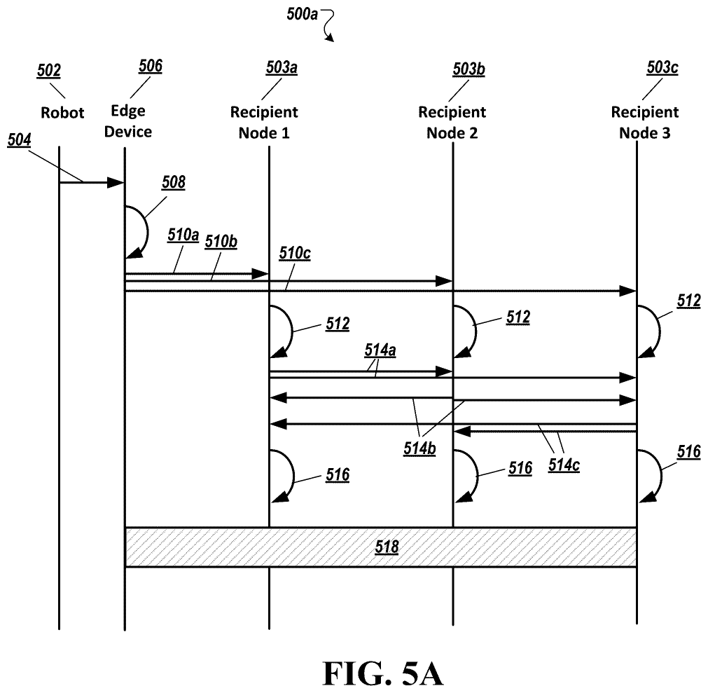

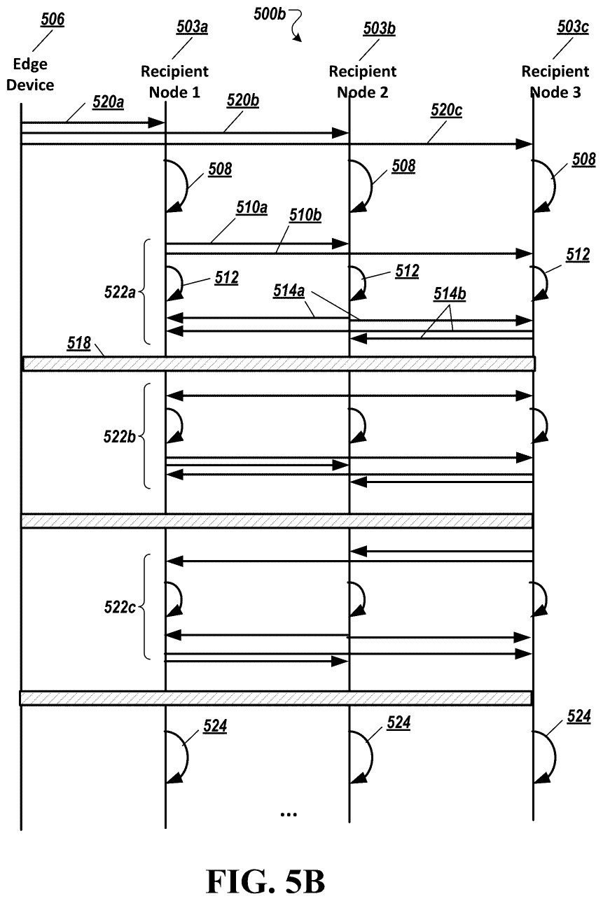

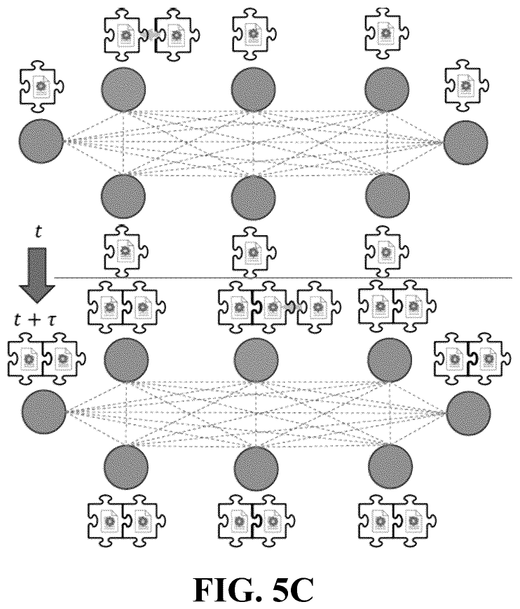

FIG. 5A shows an example operation 500a of the method 300a and algorithm 400b for node 502 (shown as “Robot” 502) to share data with a set of device 503 (shown as “Recipient node 1” 503a, “Recipient node” 503b, and “Recipient node” 503c) in its network (e.g., heterogeneous, decentralized operating multi-robot system (MRS) network) through an intermediate device 506 (shown as “Edge device” 506). In the example shown in FIG. 5A, the node 502 (shown as robot 502) is shown providing 504 data to a sharer node 506 (shown as edge server 506). The sharer node 506 can perform 508 functions 412, 420, 424, 425, 426 to generate the Merkle tree and part-leaf node association, the encrypt data, the key hash, and add them to a new block in a blockchain. The sharer node 506 can also split 508 the key and generate the partial hash of the split keys. The sharer node 506 can then, via its blockchain module, transmit 510 (shown as 510a, 510b, 510c) the block to the respective recipient nodes 503a, 503b, 503c.

Then, at the respective recipient nodes 503a, 503b, 503c, the node 503 performs 512, a verification of its local key and local key hash. It then exchanges its local partial key hash with the other recipients. Recipient node “1” 503a transmitting (514a) its local key and key hash to recipient nodes “2” and “3”, Recipient node “2” 503b transmitting (514b) its local key and key hash to recipient nodes “1” and “3”, and Recipient node “3” 503c transmitting (514c) its local key and key hash to recipient node “1” and “2”. Each node 503 then verifies 516 the exchanged keys and key hashes by reconstructing the complete hash using the provided Merkle Tree topology and then reconstructing the key to decrypt the encrypted data. Subsequently, a consensus operation 518 is performed via blockchain operation to join the new block to the blockchain.

In FIGS. 4B and 5A, the communication exchange, encryption, decryption, and key management operation can be fully performed by smart contracts in an autonomous manner or partially performed in a partial manner.

FIGS. 6C-6F show examples of messages transmitted as block transactions for a new block being added to a blockchain. FIG. 6C shows an example block containing global model distribution transactions ensured by smart contracts. FIG. 6D shows an example block containing Merkle tree-based key management transactions ensured by smart contracts. FIG. 6E shows an example block containing local training transactions ensured by smart contracts. FIG. 6F shows an example block containing local model upload ensured by smart contracts.

### Example Method of Operation-Multiple-to-Multiple Communication Exchange

FIGS. 3C and 3D show an example method 300 (shown as 300c, 300d) of operation for the sharer and recipient, respectively, in multiple-to-multiple communication using smart contracts in blockchain and Merkle Tree-based key management operations. A multiple-to-multiple communication data can be used for local model uploading, where N robot nodes upload their local updated model to M edge nodes, followed by the initialization by a delegated robot node.

In the case that multiple nodes are sharing their data or model with multiple recipients, for example, the local control or model update (e.g., in federated learning), the key management follows a multiple-to-multiple key sharing procedure as shown in FIG. 6B. Each robot encrypts its updated local control or model and splits the key into M parts as given by RobotSharer in Algorithm 3 in FIG. 4C. Similar to the one-to-multiple scenario, the delegated robot node generates a Merkle tree MT, with M leaf nodes, and a randomized key part-leaf node association ϕ. The robot node transmits the key part-leaf node association to the remaining N−1 robot nodes and the Merkle tree topology to all M edge nodes as given by DelegatedRobot in Algorithm 3. Subsequently, all robot nodes transmit the key parts following the received key part leaf node association to all M edge nodes. In FIG. 4C, a delegated robot 448 calculates a Merkle tree MT, and key part-leaf node association øn. The delegated robot 448 then shares in a distribution function 450, 452 the generated Merkle tree MTn and the key part-leaf node association ϕₙ.

Rather than the one-to-multiple scenario, the delegated robot node (e.g., Robots A, B, C, D in FIG. 6B) lacks the keys from other robot nodes. This is because the fundamental design principle emphasizes the avoidance of full key transmission. Consequently, the recipients, lacking a unique hash set, must exchange their hashes to calculate the Merkle root via the edge nodes (e.g., Edges 1, 2, 3, 4). Although the key part-leaf node association ϕₙ remains unknown to the edge recipients (e.g., Edges 1, 2, 3, 4), they can exchange hashes (e.g., H(A₁, C₂), H(B₁, C₁), H(B₂, D₂), H(A₂, D₁)) based on the Merkle tree topology. Following the computation of the Merkle root, all recipients add the key part-leaf node association as transactions on the blockchain, a process ensured by smart contracts. Finally, all Merkle roots should be consistent, and any node presenting a wrong or made-up key part will be detected and located immediately.

Sharer Operation. FIG. 3C shows the method 300c from the perspective of a single sharer in a many-to-many or multiple-to-multiple configuration. FIG. 4C shows an example algorithm 400c for the multiple-to-multiple key management system. The RobotSharer function 408′ shows the operation performed by the sharer device, e.g., as described in relation to FIG. 3C.

In FIG. 3C, the operation performs multiple-to-multiple communication using smart contracts in blockchain, and Merkle Tree-based key management operations are similar to the one-to-many operation 300a. In FIG. 3C, similar operations as those performed in FIG. 3A are shown with the same substeps and reference number. In FIG. 3C, Method 300c additionally includes transmitting (326) a randomized key part-leaf node association (328), shown in function 452.

In the example shown in FIG. 3C, Method 300c includes encrypting (304) control or communication data to be shared with a plurality of robots and associated edge nodes as an encrypted message using a key (e.g., wherein the key is generated as a hash of the control or the communication data or (ii) a pseudorandom number). An example of the encrypting operation 304 of FIG. 3C is shown as function 412 in FIG. 4C using data or model portion w_{i,e} 414, and a key 416 to generate an encrypted data w_{i,E} 418.

Method 300c then includes generating (306), via a hashing operation, (i) a complete key hash as a hash of the key and (ii) a Merkle tree having nodes comprising a plurality of partial key hashes split from the complete key hash. An example of the hashing operation 304 of FIG. 3C is shown as function 420 in FIG. 4C using the key 416 to generate the complete key hash H_{key,i} 422. FIG. 6A shows an example of the Merkle tree.

In FIG. 6A, a Merkel root, denoted as H(ABCD), is generated by hashing the combination of keys ABCD. The recipient robots include Robot 1, Robot 2, Robot 3, and Robot 4. Robot 1 has a unique key A and a set of hashes H(A); Robot 2 has a unique key B and a set of hashes H(B); Robot 3 has a unique key C and a set of hashes H(C); and Robot 4 has a unique key D and a set of hashes H(D).

The intermediate Merkel root, denoted as H(AB), is generated by hashing key A from Robot 1 and key B from Robot 2 together, and another intermediate Merkel root, denoted as H(CD), is generated by hashing key C from Robot 3 and key D from Robot 4 together.

The recipients (i.e., recipient robots A, B, C, D) can then utilize the received Merkle tree topology, along with their unique key part (e.g., H(A), H(B), H(C), H(D)) and set of hashes (e.g., H(A), H(B), H(C), H(D)), to compute the Merkle root (e.g., H(ABCD)). Subsequently, the recipients record these intermediate Merkle roots (e.g., H(AB), H(CD)) as transactions to the blockchain, an operation ensured by smart contracts. Given that all the intermediate Merkle roots coincide with the one calculated by the sharer edge node, nodes possessing an incorrect or fabricated key part may be instantly detected and identified. Following this, the recipients interchange their key parts, combine them to authenticate the hash originating from the delegated node, and then decrypt the encrypted model.

Method 300c then includes adding and transmitting (308), via the blockchain module, as a new block of a blockchain, the encrypted message, and the complete key hash, wherein the blockchain is distributed to the plurality of robots or associated edge nodes. An example of the blockchain operation 308 to add a new block of FIG. 3C is shown as function addTXNandMine 424 in FIG. 4B for the sharer node using the complete key hash H_{key,i}. The initShare function 425 creates, for the sharer i from the complete key hash H_{key,i} and the number of recipients M, a Merkle Tree MT, key part-leaf node association ϕₙ, key parts {γ₁, . . . , γ_{N}}, and corresponding partial hash of the key parts {H₁, . . . , H_{N}}. An example of the key part-leaf node association ϕn 430 is shown in FIG. 6B. As shown in FIG. 6B, the association on shows a robot or equipment being associated with two edge devices and two edge devices having a pairing.

Method 300c then includes transmitting (310) (i) the Merkle tree, (ii) a partial key hash of the plurality of partial key hashes, and (iii) a partial key of the plurality of partial keys to each respective node of the plurality of robots or associated edge nodes. An example of the distribution operation 310 of FIG. 3A is shown as function Distribute 426′ that transmits, from sharer node i to the recipient nodes M, the new blockchain block having the key part-leaf node association ϕ, key parts {γ₁, . . . , γ_{N}} and corresponding partial hash of the key parts {H₁, . . . , H_{N}} the encrypted data w_{i,e}.

Then, at the recipient node, the node is configured to (i) receive the transmitted partial key hash as a first local partial key hash and received the partial key, (ii) receive the randomized key part-leaf node association; (iii) transmit the first local partial key hash and received partial key to a paired node among the plurality of robots or associated edge nodes, (iv) receive, at least, a second local partial key hash corresponding to the paired node from the paired node and a corresponding partial key of the second local partial key hash, (v) construct a local complete key hash from the first local partial key hash and, at least, the second local partial key hash, (vi) validate the new block in the blockchain via a smart contract operation of the blockchain if the constructed key hash matches the complete key hash in the new block, and (v) decrypt the control or communication data from the encrypted message using a key generated from (i) the Merkle tree, (ii) the received partial key of the first local partial key hash, (iii) the receive the randomized key part-leaf node association and, at least, (iv) the received partial key of the second local partial key hash.

Recipient Operation. FIG. 3D shows the method 300d from the perspective of each recipient in the multiple-to-many configuration. Method 300 includes receiving (shown as 316′), from a delegated device corresponding to one of the plurality of robots and associated edge nodes, (i) a Merkle tree having nodes comprising a plurality of partial key hashes split from the complete key hash, (ii) a partial key hash of the plurality of partial key hashes, (iii) a randomized key part-leaf node association (328); and (iv) a partial key of the plurality of partial keys. In step 316′, the randomized key part-leaf node association is additionally employed as compared to operation 316 described in relation to FIG. 3B.

Method 300d includes receiving (318), at least, from a paired node, (i) a second local partial key hash corresponding to the paired node, and (ii) a corresponding partial key of the second local partial key hash. In the example shown in FIG. 4C, the Recipient function 410′ also performs a VerifyAllMerkleRoots ( ) function 440 that exchanges the local partial key hash from the recipients. Upon a successful Merkle tree root validation, the key can be exchanged.

Method 300d includes constructing (320) a local complete key hash from the first local partial key hash and, at least, the second local partial key hash. In the example shown in FIG. 4C, the Recipient function 410′ performs an ExchangeKeyParts function 442 to send its local partial key γ₁ and receive from the N recipients the key parts {γ₁, . . . , γ_{N}} 432.

Method 300d includes validating (322) the new block in the blockchain via a smart contract operation of the blockchain if the constructed key hash matches the complete key hash in the new block. In the example shown in FIG. 4C, the Recipient function 410′ performs the RestoreKey function 444 that combines the key parts {γ₁, . . . , γ_{N}} 432 into the key 416 and then performs a VerifyKeyHash function 446 using the complete key 416′ and the complete key hash 422′.

Method 300d includes decrypting (324) the control or communication data from the encrypted message using a key generated from (i) the Merkle tree, (ii) the received partial key of the first local partial key hash, (iii) the received randomized key part-leaf node association (328), and, at least, (iv) the received partial key of the second local partial key hash. In the example shown in FIG. 4C, the Recipient function 410′ performs a Decrypt function 446 using the encrypted data w_{i,e} 418 and completed key 416′ to generate the decrypted data w_{1:N}.

Key part-leaf node association. In steps 316′ and 324′, the randomized key part-leaf node association is additionally received as employed to the operation 316 described in relation to FIG. 3B. In FIG. 6B, each recipient edge node receives multiple key parts from multiple robot nodes. Each node then calculates the hash and exchanges its hashes iteratively to compute the Merkle root. All robot nodes transmit the key parts following the received key part leaf node association to all M edge nodes.

FIG. 5B shows an example operation 500b of the method 300c and algorithm 400c for node 502 (shown as “Robot” 502) to the sharing of data or model among a set of device 503 (shown as “Recipient node 1” 503a, “Recipient node” 503b, and “Recipient node” 503c) in its network (e.g., heterogeneous, decentralized operating multi-robot system (MRS) network). In the example shown in FIG. 5B, a delegated node 502 (shown as “Edge node” 502) initiates a multiple-to-multiple communication session and generates a Merkle tree and a part-leaf node association for the tree. The delegated node 502 then shares 520a, 520b, 520c (e.g., via distribution function 450, 452) the generated Merkle tree MTn and the key part-leaf node association ϕₙ.

Each sharer node 506 can then perform 508 functions 412, 420, 424, 425, 426 to generate the Merkle tree and part-leaf node association, the encrypted data, the key hash, and add them to a new block in a blockchain. Each sharer node 506 can also split 508 the key and generate the partial hash of the split keys. Each sharer node 506 can then, via its blockchain module, transmit 510 (shown as 510a, 510b, 510c) the block to the respective recipient nodes 503a, 503b, 503c in a sequence 522 (shown as 522a, 522b, 522c). In each session, each of the two recipient nodes 503 performs 512, a verification of its local key and local key hash. It then exchanges its local partial key hash with the other recipients. Each node 503 then verifies the exchanged keys and key hashes by reconstructing the complete hash using the provided Merkle Tree topology and then reconstructing the key to decrypt the encrypted data. Subsequently, a consensus operation 518 is performed, via blockchain operation, to join the new block to the blockchain for each of the transaction 522. The process is then repeated for each of the nodes until the control or model parameters have been shared. Subsequent to that, each node then updates 524 its model, and the process is then repeated. FIG. 5C shows a blockchain with smart contracts and DPoW. The delegation follows a round-robin style.

### Experimental Results and Additional Examples

A study was conducted to develop a Merkle tree-based key management system configured to preserve privacy and encrypt information prior to wireless exchange, with decryption requiring the joint effort of recipients. The study integrated complementary Merkle tree-based key management and smart contracts to automate MRS's data collection, data sharing with decryption and decryption, and ML workflow. The evaluation shows that the decentralized characteristics of MRS in smart factories align with blockchain technology, and smart contracts, thereby facilitating real-time detection and localization of cyber errors within MRS-driven smart factories. The study showed that the technology can be extended to various other industrial scenarios and even to smart city applications, wherein MRSs interact with the physical world while executing tasks facilitated by distributed computing.

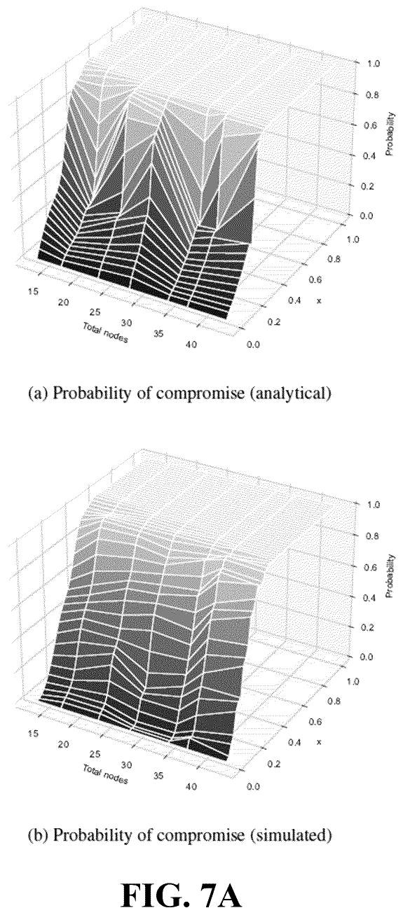

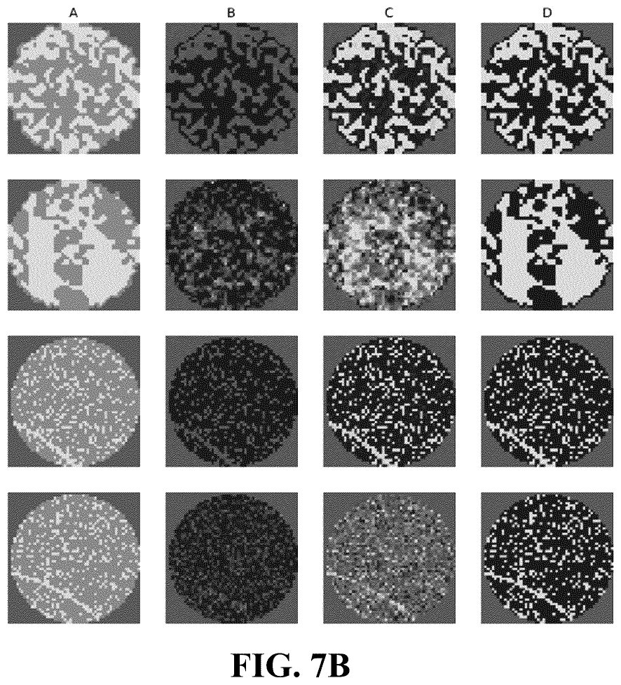

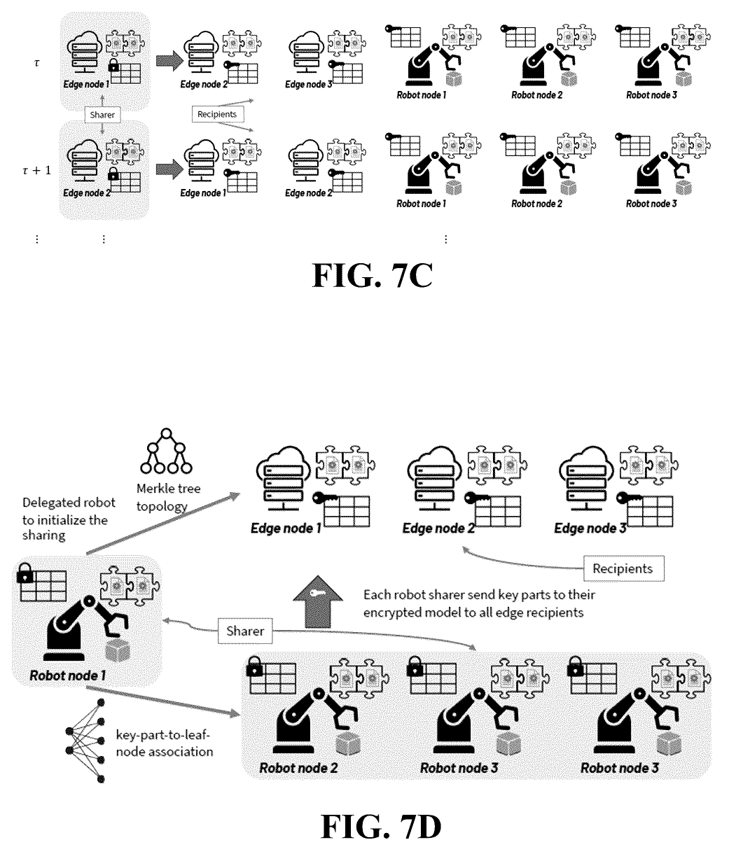

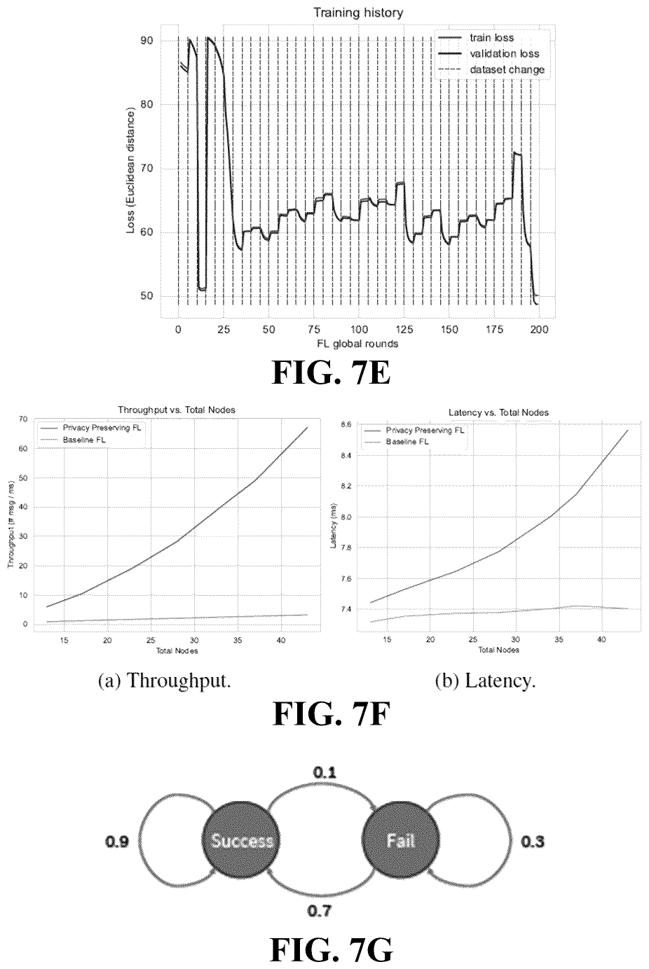

FIGS. 7A-7G show experimental results from a study conducted to develop a blockchain Merkle tree-based key management system.

Probabilistic analysis of compromise. In the exemplary key management system employed in the study, the integrity of both robot cyber operations and key management operations is ensured by smart contracts. The exemplary key management system follows the two principles and renders external breaches particularly challenging. To demonstrate the efficacy of the exemplary key management system, the study conducted an analysis that extends beyond mere privacy concerns. The following results substantiated the effectiveness of the exemplary key management system in pre-serving both integrity and privacy.

Specifically, the study based the malicious operations on some insider information. The study created some made-up malicious nodes to pretend to comply with the smart contracts with wireless sniffing of key parts. The study assumed that x key parts were intercepted during a model distribution step facilitated by Merkle tree-based key management and smart contracts, and the attacker remained unaware of the key part-leaf node association, as this was generated randomly by the sharing node. If at least two obtained key parts corresponded to two nodes in the Merkle tree sharing a common parent node, the attacker may calculate the hash of the parent node by complying with the smart contracts.

The probability of a malicious operation event may be calculated based on the collectively exhaustive events where all key parts obtained by the attacker are derived from different parent nodes, as presented in Equation 1.

$$P r ( M + N , x ) = 1 - \frac{( \begin{matrix}x \\ \frac{M + N}{2}\end{matrix} )}{( \begin{matrix}x \\ M + N\end{matrix} )} \qquad ( Eq . l )$$

In Equation 1, Pr(.) denotes the probability function, M denotes the number of edge nodes, N denotes the number of robot (i.e., recipient) nodes, and x denotes the key parts.

By repeatedly applying this process, the likelihood that the attacker calculates the correct Merkle root may be expressed as a function of the obtained key parts x and the total number of nodes M+N. Assuming that each iteration is Identically and Independently Distributed (I.I.D.), the probability of system compromise, i.e., the attacker being able to calculate the correct Merkle root, may be represented as given by Equation 2.

$$Pr ( compromise ) = Pr ( M + N , x ) . Pr ( \frac{M + N}{2} , \frac{dx}{2} ) = Pr ( 1 , 1 ) \qquad ( Eq . 2 )$$

The study conducted both analysis and simulation with the same assumptions to evaluate the probability of a system compromise. FIG. 7A, subpanel A, and subpanel B, respectively show analytical and simulated probability of compromise for the exemplary key management system. Table 1 shows the parameters (e.g., edge nodes and robot nodes) of the probabilistic analysis of compromise.

TABLE 1

| Variable | Quantity |
|---|---|
| M | (4, 4, 4, 5, 5, 6, 6) |
| N | (9, 13, 19, 23, 29, 31, 37) |

As shown in FIG. 5, the analytical probability of compromise in subpanel (a) was consistent with the simulated probability of compromise in subpanel (b). When increasing the value of x, the probability of system compromise increased, which was also consistent with the intuition that the more key parts the attacker may obtain, the higher the probability of system compromise.

Federal Learning Case Study. The study evaluated the Merkle tree-based key management system and privacy performance in the context of a case study involving federated learning across multiple robots and sites. Federated learning (FL), as a decentralized privacy-preserving Machine Learning (ML) technique, can allow robots in different spatial locations to simultaneously and collaboratively learn from local data [36] to effectively achieve the goal of MRS, without actually exchanging the local data. Applying FL in smart factories can facilitate the coordination of multiple sub-MRSs regarding their heterogeneous tasks, raw materials, components (sub-assemblies), energy supply, etc [37], which aligns with the discussed MRS architecture. The MRS(s) in smart factories may adapt in real-time to time-dynamic production demands and optimize productivity, resource efficiency, and even resilience through FL.

In the nature of FL, the local data is not shared. Rather, the ML model (parameter weights) can be transmitted among the robots and edge nodes. Because model parameters can be intercepted by unauthorized nodes, FL can be undermined in terms of privacy. Also, it has been observed that malicious participating nodes may attack (e.g., perform Sybil attacks or the like) to disrupt the FL process without the authenticity verification enforced by smart contracts.

In adopting the smart contracts and Merkel tree-based key management in this example use-case, the study demonstrated the exemplary key management system by adapting FL to the batch variations of raw materials in a smart factory utilizing published datasets. This can introduce inconsistencies in the manufacturing process, which may impact product quality and yield [39], [40]. The study adopted both the workflow of FL and the consensus mechanism of blockchain to multiple edge servers as controller nodes under a smart factory context.

On-device federated learning for an MRS-driven smart factory. In the evaluation, for a smart factory with M edge computing nodes and N robot nodes, M, N∈I, the training of FL only took place directly on N robot nodes (known as the client in FL) with immediate collected data. M edge nodes then serve as central controllers, keeping the global model θₘ^{t}, m=1, . . . , M and distributing them to N robot nodes as clients, while N robot nodes uploaded their local model, wₙ^{t}, n=1, . . . , N to the edge nodes. This can provide basic privacy preservation since the local data never left the robot nodes, as well as reduced communication overhead since only models are transmitted.

During the process of performing assigned manufacturing tasks, robots simultaneously then collect a dataset to adapt to time dynamics through FL. The FL model trained by this dataset allowed them to adjust to temporal dynamics and optimize task execution parameters for enhanced efficiency, output, and resilience. Let Dₙ^{τ}={Bₙ¹, Bₙ², . . . , Bₙ^{t}} represent the time-varying dataset collected by the n^{th} robot, which included batches Bt. Here, t distinguished local training epochs, whereas τ corresponds to global FL iterations. The local objective function of FL, Fₙ(wₙ), as specified in Equation 3 was determined by the data Dₙ and a domain-specific loss function l(·, ·), which was not distinguished by time.

$${F}_{n} ( {w}_{n} , {D}_{n} ) = \frac{1}{\vert {D}_{n} \vert} {\sum }_{{B}_{n} = {D}_{n}}^{N} ℓ ( {w}_{n} , {B}_{n} ) \qquad ( Eq . 3 )$$

Federated Averaging (FedAvg) is a well-known FL algorithm that can globally identify the optimal model parameters, denoted as θ. This optimization can minimize the global objective function F(θ, D) given a hypothetical global dataset D, e.g., per Equation 4.

$${min}_{θ} \{ F ( θ , D ) = {\sum }_{n = 1}^{N} {p}_{n} {F}_{n} ( θ , {D}_{n} ) \} , {D}_{n} ∈ D$$

### (Eq. 4)

In Equation 4, the constraint Σₙ₌₁^{N}pₙ=1 enables the weighted average of the local objectives provided by the individual robots. There were five steps in FL in the study for an MRS-driven smart factory that comprised one global FL iteration.

Step 1—Global model distribution. Start with all edge nodes having the same global model, θ₁^{τ}:=θ₂^{τ}:= . . . :=θ_{M}^{τ}, as the mth edge node distributed its model to all robot nodes as in Equation 5.

$$∀ n ∈ N , {w}_{n}^{t} = {θ}_{m}^{τ} \qquad ( Eq . 5 )$$

Step 2—Local training. Each robot node collected some batches of data Bₙ^{t} from task execution and performs e local training epochs with learning rate η, where each epoch was defined by Equation 6.

$$∀ n ∈ N , {w}_{n}^{t + 1} = {w}_{n}^{t} - η ∇ {F}_{n} ( {w}_{n} , {B}_{n}^{t} ) , {B}_{n}^{t} ∈ {D}_{n} \qquad ( Eq . 6 )$$

Step 3—Local model upload. Each robot node transmitted the new local model and corresponding fraction coefficient |Bₙ^{t}| (cardinality of a set By, not the dataset batch) to an edge node. Edge node m had a set {w₁^{t+e}, . . . , w_{N}^{t+e}} and {|(B₁^{t}, . . . , B₁^{t+e})|, . . . , |(B_{N}^{t}, . . . , B_{N}^{t+e})|}

Step 4—Model aggregation. Edge node m used an aggregation approach such as FedAvg to form a new global model given by Equation 7.

$${θ}_{m}^{τ + 1} = {\sum }_{n = 1}^{N} {p}_{n}^{t} {w}_{n}^{t + e} , {p}_{n}^{t} = \frac{\vert ( {B}_{n}^{t} , … , {B}_{n}^{t + e} ) \vert}{{\sum }_{j = 1}^{N} \vert ( {B}_{j}^{t} , … , {B}_{j}^{f + e} ) \vert} \qquad ( Eq . 7 )$$

Step 5—Global update and synchronization. Edge node m communicated with other edge nodes to synchronize their global models, as shown in Equation 8.

$$∀ i ∈ \{ 1 , … , M \} \{ m \} , {θ}_{i}^{τ + 1} = {θ}_{m}^{τ + 1} \qquad ( Eq . 8 )$$

The optimization of the local objective was achieved by Stochastic Gradient Descent (SGD) with a learning rate n, given by Equations 9 and 10.

$$w = w - η \frac{\partial ℓ}{\partial w} \qquad ( Eq . 9 )$$

$$\frac{\partial ℓ}{\partial w} \approx \frac{1}{\vert {B}_{n}^{t} \vert} {\sum }_{k ∈ \vert {B}_{n}^{t} \vert} \frac{\partial {ℓ}_{k}}{\partial w} \qquad ( Eq . 10 )$$

In the study, the data collected by robots, local models and global models were all confidential information that should be protected from unauthorized access, while the global model distribution step and the local model upload step were vulnerable to privacy leakage. In addition, the model aggregation step was vulnerable to Sybil attacks without legitimacy validation, which may result in cyber error and defects, degrading the resilience.

Adapting to batch variation of raw material with FL. The study used the “MixedWM38” dataset [41] in a smart factory setting within the semiconductor industry. As the fundamentals for the production of integrated circuits (ICs) and a variety of electronic components, the operation of wafers encompassed deposition, etching, photolithography, doping, dicing, assembly, and testing. These processes may be executed by a heterogeneous Multi-Robot System (MRS). Various studies, including [41], [42], and [43], investigated Machine Learning (ML) based wafer defect pattern recognition, which is useful for distinguishing batch variations of wafers when they are processed by an MRS.

The study developed a unified model representing different operations on wafers to demonstrate the integrity and privacy preservation of the exemplary key management system. In this model, the robot manipulated only normal dies or approaches as close as possible to such. The study represented a wafer as a matrix A, where aᵢⱼ=0 signified an empty space; aᵢⱼ=1 indicated the presence of a normal die; and aᵢⱼ=2 represented a failed die. The study defined the task execution parameter for the robot as a matrix B, which shared dimensions with A, and the execution of the task was defined as C=A+B. The study further assumed a “paradigm” matrix D describing the perfect task execution outcome, wherein D: =A−2(A==1) resulted from a logical operation that introduced non-linearity mathematically. The FL's goal was to minimize the Euclidean distance between C and D, which was equivalent to calculating the L2 norm of the difference between the two matrices, resulting in a convex problem, as expressed in Equation 11.

$$ℓ ( C , D ) = \vert C - D \vert \vert F = \sqrt{\sum i {\sum }_{j} {( {c}_{ij} - {d}_{ij} )}^{2}} \qquad ( Eq . 11 )$$

The study introduced the batch variation of wafers (the raw materials for the MRS) by distributing one of the 38 categories of the dataset to all the robots in a time-varying manner, which remained undisclosed to the robots. When a global iteration number was reached, the simulation switched to the next dataset for all robots, indicating the exhaustion of the previous wafer batch and the arrival of a new one. The robots adapted to such batch variation through FL and determined the task execution parameters B to minimize the loss between C=A+B and D.

FIG. 7B shows two wafer examples (A) from pattern ID C7 and C13, along with the corresponding task execution parameters B, task execution outcome C, and the paradigm task execution outcome D. The wafers from the same pattern shall be homogeneous, and the wafers from different patterns shall be heterogeneous which the robots needed to adapt.

Smart contract for the integrity of FL. While the Merkle tree-based key management system was specifically engineered to preserve privacy during model exchange, its execution-along with other steps in FL—was ensured by smart contracts to ensure integrity. The implementation of smart contracts in an FL framework, which incorporated M edge nodes (serving as FL controllers) and N robot nodes (acting as FL clients), provided a foundation for both the integrity and privacy preservation associated with the five critical stages of FL.

During the beginning global model distribution phase, as depicted in FIG. 7C, a smart contract was used to designate an edge node to carry out the model distribution. This was accomplished by following the process outlined in the algorithm, e.g., as described in relation to FIG. 4A. The updated global model was encrypted, and the corresponding key was split into several parts. This key fragmentation resulted in a Merkle tree with an associated key part-leaf node mapping. Each recipient was then sent a uniquely assigned key part, the Merkle tree topology, and a necessary hash set. Simultaneously, a blockchain transaction was added, involving the hash of the entire key to the encrypted model within it.

Each recipient node, including the remaining M−1 edge nodes and the N robot nodes, responded by adding a transaction that included the calculated Merkle root, derived from their individual key parts, the Merkle tree topology, and the necessary hash set. It was only when all the Merkle roots aligned consistently that all recipient nodes shared their key parts with the other nodes. This step further integrated the global model update, synchronization and distribution procedures integral to the FL process.

During local training, each robot node added a transaction on the blockchain. This transaction included the dataset's identity and size (pₙ), as well as the hash of the key corresponding to the encrypted, updated local model. Following this, the selected robot node generated a Merkle tree that associated key parts with leaf nodes. It then distributed the Merkle tree's topology to all edge nodes and transmitted the key part-leaf node association to the remaining robot nodes.

Each robot node then transmitted the key parts according to the key part-leaf node association. All edge nodes exchanged hashes until they computed the Merkle root. At this point, they appended a transaction containing the Merkle root to the blockchain, a process visualized in FIG. 7D. Once again, the edge nodes only exchanged key parts with all other edge nodes when all the Merkle roots aligned.

The model aggregation step required the delegated edge node to add an additional transaction. This transaction incorporated the global FL iteration count and the identifier of the edge node.

The smart contracts presented in the algorithm shown in FIG. 4D ensured integrity in the aforementioned steps by mapping each action to a corresponding transaction in the blockchain. This transparency and traceability of operations were critical in the setup. During the process of implementing the Merkle tree-based key management, recipients did not require knowledge of the key part-leaf node association within the Merkle tree while the models remained encrypted during transmission; all the keys were disseminated in parts.

Furthermore, the study formulated the algorithms in FIG. 4A, FIG. 4B, FIG. 4C, and FIG. 4D with scalability. The first argument of functions, including addTXN, addTXNandMine, InitShare, and Distribute, represented the identifier of the node executing the function. The scalability and immutability were both ensured since once the smart contracts were deployed, they should not be further modified [44].

The federated learning can be executed for one or more artificial intelligence and machine learning operations. The term “artificial intelligence” can include any technique that enables one or more computing devices or comping systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

Machine learning models include supervised, semi-supervised, and unsupervised learning models. In a supervised learning model, the model learns a function that maps an input (also known as feature or features) to an output (also known as target) during training with a labeled data set (or dataset). In an unsupervised learning model, the algorithm discovers patterns among data. In a semi-supervised model, the model learns a function that maps an input (also known as a feature or features) to an output (also known as a target) during training with both labeled and unlabeled data.

Neural Networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as an input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an ANN is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similarly to traditional neural networks. GCNNs are CNNs that have been adapted to work on structured datasets such as graphs.

As used herein, the term “encoder-decoder AI model” describes an architecture of a machine learning system in which input data are encoded or coded in order then to be decoded again immediately afterward. In the middle between the encoder and the decoder the necessary data are present as a type of feature vector. During decoding, depending on the training of the machine learning model, specific features in the input data can then be specially highlighted.

As used herein, the term “U-net” describes the architecture of a machine learning system that is based on a convolutional network architecture. This architecture is particularly well suited to a fast and accurate segmentation of digital images in the biological/medical field. A further advantage of such a machine learning system is that it manages with less training data and allows a comparatively accurate segmentation.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., an error such as L1 or L2 loss), during training. This disclosure contemplates that any algorithm that finds the minimum of the cost function can be used. LR classifiers are known in the art and are therefore not described in further detail herein.

A Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

The exemplary system and method can be based on any type of machine learning or artificial intelligence system, including, and not limited to, convolutional neural networks, autoencoders, recombinant neural networks, and long-term short-term memory (LSTM) networks.

Computational experiment. In the FL experiment, the study allocated 17% of the dataset for validation to confirm the assumptions regarding the loss function. As the loss function was selected for proof-of-concept purposes, its absolute value did not carry physical significance.

FIG. 7E shows the training and validation losses of federated learning (FL), with the vertical dotted line indicating the point of dataset switching in terms of FL global iterations. This switching setup analogues the arrival of a new batch of wafers in the smart factory but without pre-defined tuning, quality and yield optimization phase. The yield improvement was known as a challenge in the semiconductor industry and potentially may be addressed by a smart factory. As shown in FIG. 7E, after the initial adaptation to the new batch of wafers, the loss became stable but still varied due to the batch variations. This observation was aligned with the practical problem that each batch of wafers had its unique characteristics and optimal task execution parameters varied accordingly.

As shown in FIG. 7E, both the training and validation losses decreased over the FL global iterations. Each time the dataset switched, there was an expected increase in loss, as the robots needed time to adapt to the new batch of wafer patterns. The loss began to decrease again once the robots adjusted to the new batch. The optimal loss may differ since the method of modeling task execution C=A+B was not unique.

FIGS. 6C-6F show four distinct blocks in the blockchain. These were extracted from an experiment involving M=4 edge nodes (ID 100, 101, 102, 103) and N=9 robot nodes (ID 0, 1, . . . , 8). The study simplified the experiment settings to these parameters rather than M=6 and N=37 for illustrative purposes.

FIG. 6C shows the delegation of global model distribution to edge node 1 (ID 100). This node added a transaction to the blockchain that included the FL iteration number, the executor node ID, and the hash of the key corresponding to the global model. FIG. 6D shows transactions associated with the Merkle tree-based key management system during the global model distribution process. All robot nodes and edge nodes, excluding the delegated edge node 1 (ID 100), added transactions to the blockchain. These transactions comprised the Merkle root calculated from the key parts, the Merkle tree topology, and the necessary hashes received from edge node 1 (ID 100). Only after all nodes verified all the Merkle roots, transactions containing the key parts were added to the blockchain. FIG. 6E shows the local training transactions originating from the robots. These transactions included the dataset ID, dataset volume (pₙ), and the hash of the key to the local model. FIG. 6F shows the local model upload transactions from the edge nodes, which included the Merkle roots they calculated. Once the robot node delegated for local model uploading verified all the Merkle roots, all edge nodes exchanged their key parts for the full key.

All the transactions detailed above were immutable and accessible to all nodes in the blockchain network, ensuring the integrity of the FL process. Any malicious activities, including missing transactions, incorrect Merkle roots, and inconsistent dataset IDs, may be immediately detected by any node in the network, thereby preserving the integrity of FL as well as the Merkle tree-based key management system.

Increased bandwidth consumption and enlarged latency in wireless. The exemplary key management system, while aiming to ensure operational integrity and privacy preservation, did require a corresponding increase in wireless resources. This increased bandwidth consumption stems from the decentralized storage inherent to the blockchain, as well as the transmission of key parts and hashes associated with the Merkle tree-based key management system. Additionally, there was an added latency arising from the blockchain's consensus mechanism (DPOW) and the legitimacy validation process in the Merkle tree-based key management system.

To evaluate the impact of such increases, the study conducted an experiment that contrasted wireless overhead in scenarios with and without the incorporation of the Merkle tree-based key management system and smart contracts. Given that the size of FL models, key components, and blockchain transactions may vary depending on the specific implementation, the study focused on estimating these communications at the message level.

Unlike the conventional FedAvg structure, the MRS included multiple edge computing nodes functioning as controllers and performing model aggregation and model update operations in a delegated fashion. For the baseline comparison in this study, classical FL was considered where a designated edge node distributed the global model to all robots as well as other edge nodes.

The study introduced additional wireless overhead from two main aspects. The first arose from the distribution and exchange of key parts facilitated by the Merkle tree-based key management system. As the exemplary key management system necessitated recipients to possess key parts, the Merkle tree topology, and essential hashes for calculating the Merkle root and then transmit these key parts to all other nodes that correctly calculated the Merkle root, this resulted in additional wireless overhead.

The second additional overhead source was from the blockchain transactions ensured by smart contracts. Since the study utilized blockchain with smart contracts to ensure and store immutable records of essential FL steps and key management steps as transactions, it led to additional transaction transmissions and block validation transmissions through the consensus mechanism. Although the proposed DPOW consensus mechanism mitigated this issue by preventing multiple nodes from adding blocks simultaneously to conserve wireless and local computing resources, other use case-specific consensus mechanisms for private blockchains may be utilized to further optimize the wireless overhead.

FIG. 7F, subpanel A and subpanel respectively shows the throughput and latency results. In the latency analysis, the transmission latency data focused on Machine-type Communication (MTC) in industrial scenarios [45]. Meanwhile, the study modeled the transmission as a two-state Markov process as shown in FIG. 7G. Both the throughput and latency of base-line FL increased with the total number of nodes. However, compared to the privacy-preserving FL, such increases were not significant. For both throughput and latency, privacy-preserving FL was showing an exponential increase with the total number of nodes.

The computational experiments demonstrated the feasibility, effectiveness, and efficiency of the integrity and privacy preservation FL. The integrity was suggested by the transactions in the blockchain, where the smart contracts ensured the FL steps and key management steps. When cyber errors happened, they may be immediately detected and located, paving a path for adjustments and recovery, which further facilitated the resilience of smart factories. Privacy preservation was suggested by the Merkle tree-based key management system, where the key parts were distributed and exchanged in a partial, decentralized fashion and FL models were exchanged after their encryption. However, the exemplary key management system introduced additional wireless overhead, which necessitated massive machine-type communication (mMTC) and time-sensitive networking (TSN) for smart factories.

### Discussion

Facilitating cyber operation integrity and privacy preservation face multifaceted challenges. First, the cascading impact of cyber errors on physical production flows may cause point failure and be challenging to detect. Collaborative production driven by autonomous MRS experiences error accumulation and aggregation due to the temporal nature of flow-based production. Such a system is vulnerable to point errors and failures: compromising one robot may significantly reduce yield. The decentralized operation of robots, coupled with scalability requirements, makes it infeasible to exhaustively monitor and verify that every robot is performing correctly at all times. Detecting defects might be feasible, but identifying the specific robot responsible for a point failure is exceptionally challenging and computationally complex (NP-hard) [10].

Second, the heterogeneous robot system faces interoperability issues, especially regarding autonomous information exchange in the cyber domain. Robots from different vendors come with varying capabilities, data storage schemes, and communication protocols. This diversity complicates seamless integration and coordination, which are crucial for efficient operation [11].

Third, privacy preservation is a significant concern. Even when robots perform their operations and workflow correctly, the information they share can be intercepted by a malicious robot or an Internet of Things (IoT) node in the network [12], [13]. A single compromised robot may access and potentially exploit sensitive operational data. In a smart factory, this operational information is private and should be subject to strict access controls.

The aforementioned challenges highlight the need for robust encryption and secure communication protocols to protect the integrity and privacy of the system [14]. To address these challenges, a smart contracts-based autonomous operation framework with Merkel tree-based key management (i.e., Merkel tree-based key management system) is developed to ensure the integrity of cyber operations and privacy preservation in a smart factory driven by MRS. In this system, smart contracts automate the cyber operations and register them as immutable and accessible transactions within the blockchain; the key management ensures information is encrypted prior to wireless exchange, with decryption requiring the joint effort of recipients.

Additional discussion. Smart contracts with blockchain may be applied to an autonomous, heterogeneous MRS for integrity operation and privacy preservation since it provides a unified automation mechanism in the cyber domain. Previous studies [15], explored the use of smart contracts for better decentralization in 5G networks but not for smart factories and their privacy challenges. A previous study developed a privacy framework on blockchain and smart contracts for both on-chain and off-chain operations through private peer-to-peer identification. Despite it addressing integrity with identification and privacy with encryption, the key management mechanism was not addressed. A previous study presented a privacy-preserving architecture that employed digital certificates, RSA-based public key infrastructure, and blockchain to ensure the privacy and security of transaction data, but it was short in utilizing smart contracts for automation and integrity operation.

Merkle tree or a binary hash tree was a classical data structure in cryptography and computer science. Some implementations of blockchain used the Merkle tree to account for the immutability of transactions in each block [19]. A study developed a blockchain and Merkle tree-based key management scheme for vehicular communication systems scenario, including the key transfer between two heterogeneous networks and the dynamic key management scheme to decrease the key transfer time. A study exploited the blockchain and Merkle tree to ensure the integrity and security of cloud-based intelligent surveillance systems. The above two studies both used the Merkle tree to ensure integrity and security, but not within the scope of privacy preservation of an MRS-driven smart factory. Also, another study developed a decentralized key management protocol that addresses the security challenges in IoT environments but lacks demonstration in a smart factory context.

The literature review reveals that the current research on smart contracts and key management mechanisms falls short in simultaneously addressing privacy preservation and operational integrity.

The nodes (e.g., 102) can be implemented via a computing device having a processing unit (e.g., processor) configured to execute computer-readable instructions. In a configuration, the processing unit includes at least one processing circuit (e.g., core) and system memory. Depending on the exact configuration and type of computing device, system memory may be volatile (such as random-access memory (RAM)), non-volatile (such as read-only memory (ROM), flash memory, etc.), or some combination of the two. The processing unit may be a standard programmable processor that performs arithmetic and logic operations necessary for the operation of the computing device. As used herein, processing unit and processor refers to a physical hardware device that executes encoded instructions for performing functions on inputs and creating outputs, including, for example, but not limited to, microprocessors (MCUs), microcontrollers, graphical processing units (GPUs), and application-specific circuits (ASICs).

While instructions may be discussed as executed by a processor, the instructions may be executed simultaneously, serially, or otherwise executed by one or multiple processors. The processing unit may also include a bus or other communication mechanism for communicating information among various components of the computing device. In some embodiments, the processing unit is configured with co-processors (e.g., FPGA, ASIC) or AI-processors.

### CONCLUSION

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include one particular value and/or the other particular value.

By “comprising” or “containing” or “including,” is meant that at least the name compound, element, particle, or method step is present in the composition or article or method but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The following patents, applications and publications as listed below and throughout this document are hereby incorporated by reference in their entirety herein.
[1] K. C. Chen, S. C. Lin, J. H. Hsiao, C. H. Liu, A. F. Molisch, and G. P. Fettweis, “Wireless networked multirobot systems in smart factories,” Proc. IEEE, vol. 109, DOI 10.1109/JPROC.2020.3033753, no. 4, pp. 468-494, 2021.
[2] W. Wang, Y. Zhang, J. Gu, and J. Wang, “A proactive manufacturing resources assignment method based on production performance prediction for the smart factory,” IEEE Transactions on Industrial Informatics, DOI 10.1109/TII.2021.3073404, pp. 1-1, 2021.
[3] Z. Nie and K.-C. Chen, “Hypergraphical real-time multirobot task allo-cation in a smart factory,” IEEE Transactions on Industrial Informatics, vol. 18, DOI 10.1109/TII.2021.3135297, no. 9, pp. 6047-6056, 2022.
[4] Z. Nie and K.-C. Chen, “Distributed coordination by social learning in the multi-robot systems of a smart factory,” in 2021 IEEE Global Communications Conference (GLOBECOM), DOI 10.1109/GLOBE-COM46510.2021.9685165, pp. 01-06. IEEE, 2021.
[5] T. Pulikottil, L. A. Estrada-Jimenez, H. U. Rehman, J. Barata, S. Nikghadam-Hojjati, and L. Zarzycki, “Multi-agent based manufac-turing: current trends and challenges,” in 2021 26th IEEE International Conference on Emerging Technologies and Factory Automation (ETFA), DOI 10.1109/ETFA45728.2021.9613555, pp. 1-7. IEEE, 2021.
[6] S. Savazzi, M. Nicoli, M. Bennis, S. Kianoush, and L. Barbieri, “Opportunities of federated learning in connected, cooperative, and auto-mated industrial systems,” IEEE Communications Magazine, vol. 59, DOI 10.1109/MCOM.001.2000200, no. 2, pp. 16-21, 2021.
[7] C. Lutz and A. Tamò-Larrieux, “Do privacy concerns about social robots affect use intentions? evidence from an experimental vignette study,” Frontiers in Robotics and AI, vol. 8, p. 627958, 2021.
[8] J. Peng, F. Bao, C. Yang, Y. Xu, Y. Qin et al., “Multi-robot privacy-preserving algorithms based on federated learning: A review.” Computers, Materials & Continua, vol. 77, no. 3, 2023.
[9] V. Terziyan, D. Malyk, M. Golovianko, and V. Branytskyi, “Encryption and generation of images for privacy-preserving machine learning in smart manufacturing,” Procedia Computer Science, vol. 217, pp. 91-101, 2023.
[10] D. Mu, X. Yue, and H. Ren, “Robustness of cyber-physical supply net-works in cascading failures,” Entropy, vol. 23, no. 6, p. 769, 2021.
[11] D. S. López, G. Moreno, J. Cordero, J. Sanchez, S. Govindaraj, M. M. Marques, V. Lobo, S. Fioravanti, A. Grati, K. Rudin et al., “Interoperability in a heterogeneous team of search and rescue robots,” Search and Rescue Robotics-From Theory to Practice, pp. 93-125, 2017.
[12] G. P. Pinto, P. K. Donta, S. Dustdar, and C. Prazeres, “A systematic review on privacy-aware iot personal data stores,” Sensors, vol. 24, no. 7, p. 2197, 2024.
[13] P. D. Singh and K. D. Singh, “Security and privacy in fog/cloud-based iot systems for ai and robotics,” EAI Endorsed Transactions on AI and Robotics, vol. 2, 2023.
[14] N. Tuptuk and S. Hailes, “Security of smart manufacturing systems,” Journal of manufacturing systems, vol. 47, pp. 93-106, 2018.
[15] Y. Liu, J. Peng, J. Kang, A. M. Iliyasu, D. Niyato, and A. A. A. El-Latif, “A secure federated learning framework for 5g networks,” IEEE Wireless Communications, vol. 27, DOI 10.1109/MWC.01.1900525, no. 4, pp. 24-31, 2020.
[16] C. Feng, B. Liu, K. Yu, S. K. Goudos, and S. Wan, “Blockchain-empowered decentralized horizontal federated learning for 5g-enabled uavs,” IEEE Transactions on Industrial Informatics, vol. 18, DOI 10.1109/TII.2021.3116132, no. 5, pp. 3582-3592, 2022.
[17] L. Ouyang, F.-Y. Wang, Y. Tian, X. Jia, H. Qi, and G. Wang, “Artificial identification: A novel privacy framework for federated learning based on blockchain,” IEEE Transactions on Computational Social Systems, DOI 10.1109/TCSS.2022.3226861, pp. 1-10, 2023.
[18] B. M. Yakubu, J. Sabi'u, and P. Bhattarakosol, “Blockchain-based privacy and security model for transactional data in large private networks,” Scientific Reports, vol. 13, no. 1, p. 17108, 2023.
[19] S. M. Fattahi, A. Makanju, and A. Milani Fard, “Simba: An efficient sim-ulator for blockchain applications,” in 2020 50th Annual IEEE-IFIP Inter-national Conference on Dependable Systems and Networks-Supplemental Volume (DSN-S), DOI 10.1109/DSN-S50200.2020.00028, pp. 51-52. IEEE, 2020.
[20] A. Lei, H. Cruickshank, Y. Cao, P. Asuquo, C. P. A. Ogah, and Z. Sun, “Blockchain-based dynamic key management for heterogeneous intelli-gent transportation systems,” IEEE Internet of Things Journal, vol. 4, DOI 10.1109/JIOT.2017.2740569, no. 6, pp. 1832-1843, 2017.
[21] D. Lee and N. Park, “Blockchain based privacy preserving multimedia intelligent video surveillance using secure merkle tree,” Multimedia Tools and Applications, vol. 80, pp. 34 517-34 534, 2021.
[22] M. A. Kandi, D. E. Kouicem, M. Doudou, H. Lakhlef, A. Bouabdallah, and Y. Challal, “A decentralized blockchain-based key management protocol for heterogeneous and dynamic iot devices,” Computer Communications, vol. 191, pp. 11-25, 2022.
[23] Z. Nie, “Cyber-physical multi-robot systems in a smart factory: A net-worked ai agents approach,” Ph.D. dissertation, University of South Florida, 2023.
[24] M. Masuduzzaman, R. Nugraha, and S. Y. Shin, “Industrial intelligence of things (iiot 2.0) based automated smart factory management system using blockchain,” in 2022 13th International Conference on In-formation and Communication Technology Convergence (ICTC), DOI 10.1109/ICTC55196.2022.9952653, pp. 59-64. IEEE, 2022.
[25] A. Khan, F. Shahid, C. Maple, A. Ahmad, and G. Jeon, “Toward smart manufacturing using spiral digital twin framework and twin-chain,” IEEE Transactions on Industrial Informatics, vol. 18, DOI 10.1109/TII.2020.3047840, no. 2, pp. 1359-1366, 2022.
[26] J. Leng, X. Zhu, Z. Huang, K. Xu, Z. Liu, Q. Liu, and X. Chen, “Manuchain ii: Blockchained smart contract system as the digital twin of decentralized autonomous manufacturing toward resilience in industry 5.0,” IEEE Transactions on Systems, Man, and Cybernetics: Systems, vol. 53, DOI 10.1109/TSMC.2023.3257172, no. 8, pp. 4715-4728, 2023.
[27] A. Ayub Khan, A. A. Laghari, Z. A. Shaikh, Z. Dacko-Pikiewicz, and S. Kot, “Internet of things (iot) security with blockchain technology: A state-of-the-art review,” IEEE Access, vol. 10, DOI 10.1109/AC-CESS.2022.3223370, pp. 122 679-122 695, 2022.
[28] T. Wang, C. Zhao, Q. Yang, S. Zhang, and S. C. Liew, “Ethna: Analyzing the underlying peer-to-peer network of ethereum blockchain,” IEEE Transactions on Network Science and Engineering, vol. 8, DOI 10.1109/TNSE.2021.3078181, no. 3, pp. 2131-2146, 2021.
[29] B. Lashkari and P. Musilek, “A comprehensive review of blockchain consensus mechanisms,” IEEE Access, vol. 9, DOI 10.1109/AC-CESS.2021.3065880, pp. 43 620-43 652, 2021.
[30] G. Ramezan and C. Leung, “Analysis of proof-of-work-based blockchains under an adaptive double-spend attack,” IEEE Transactions on Industrial Informatics, vol. 16, DOI 10.1109/TII.2020.2977689, no. 11, pp. 7035-7045, 2020.
[31] S. Windarta, S. Suryadi, K. Ramli, B. Pranggono, and T. S. Gunawan, “Lightweight cryptographic hash functions: Design trends, comparative study, and future directions,” IEEE Access, vol. 10, DOI 10.1109/AC-CESS.2022.3195572, pp. 82 272-82 294, 2022.
[32] J. Jiao, S. Kan, S.-W. Lin, D. Sanan, Y. Liu, and J. Sun, “Semantic understanding of smart contracts: Executable operational semantics of solidity,” in 2020 IEEE Symposium on Security and Privacy (SP), DOI 10.1109/SP40000.2020.00066, pp. 1695-1712. IEEE, 2020.
[33] A. Bristow and K.-C. Chen, “Robustness of quantum key distribution against quantum phase error and a new attack strategy,” in 2022 25th International Symposium on Wireless Personal Multimedia Communica-tions (WPMC), DOI 10.1109/WPMC55625.2022.10014877, pp. 273-278. IEEE, 2022.
[34] P. R. Surabhi and T. V. Meenu, “Advanced 256-bit aes encyption with plain text partitioning,” in 2021 International Conference on Advances in Computing and Communications (ICACC), DOI 10.1109/ICACC-202152719.2021.9708158, pp. 1-3. IEEE, 2021.
[35] Z. Liu, L. Ren, Y. Feng, S. Wang, and J. Wei, “Data integrity audit scheme based on quad merkle tree and blockchain,” IEEE Access, vol. 11, DOI 10.1109/ACCESS.2023.3240066, pp. 59 263-59 273, 2023.
[36] A. F. Abate, L. Cimmino, I. Cuomo, M. D. Nardo, and T. Murino, “On the impact of multimodal and multisensor biometrics in smart factories,” IEEE Transactions on Industrial Informatics, vol. 18, DOI 10.1109/TII.2022.3178376, no. 12, pp. 9092-9100, 2022.
[37] T. Zhao, F. Li, and L. He, “Drl-based joint resource allocation and device orchestration for hierarchical federated learning in noma-enabled industrial iot,” IEEE Transactions on Industrial Informatics, vol. 19, DOI 10.1109/TII.2022.3170900, no. 6, pp. 7468-7479, 2023.
[38] G. Li, J. Wu, S. Li, W. Yang, and C. Li, “Multitentacle federated learning over software-defined industrial internet of things against adaptive poison-ing attacks,” IEEE Transactions on Industrial Informatics, vol. 19, DOI 10.1109/TII.2022.3173996, no. 2, pp. 1260-1269, 2023.
[39] Z. Nie and K.-C. Chen, “Socially networked multi-robot system of time-sensitive multi-link access in a smart factory,” in ICC 2023-2023 IEEE International Conference on Communications (ICC). IEEE, 2023.
[40] S. Phuyal, D. Bista, and R. Bista, “Challenges, opportunities and future directions of smart manufacturing: a state of art review,” Sustainable Futures, vol. 2, p. 100023, 2020.
[41] J. Wang, C. Xu, Z. Yang, J. Zhang, and X. Li, “Deformable convo-lutional networks for efficient mixed-type wafer defect pattern recogni-tion,” IEEE Transactions on Semiconductor Manufacturing, vol. 33, DOI 10.1109/TSM.2020.3020985, no. 4, pp. 587-596, 2020.
[42] J. Yu and J. Liu, “Multiple granularities generative adversarial network for recognition of wafer map defects,” IEEE Transactions on Industrial Informatics, vol. 18, DOI 10.1109/TII.2021.3092372, no. 3, pp. 1674-1683, 2022.
[43] T. Sweeney, S. Coleman, and D. Kerr, “Deep learning for semiconductor defect classification,” in 2022 IEEE 20th International Conference on In-dustrial Informatics (INDIN), DOI 10.1109/INDIN51773.2022.9976162, pp. 572-577. IEEE, 2022.
[44] D. Xian and X. Wei, “Icoe: A lightweight group-consensus based off-chain execution model for smart contract based industrial applications,” IEEE Transactions on Industrial Informatics, DOI 10.1109/TII.2023.3282319, pp. 1-12, 2023.
[45] Z. Wei, L. Zhang, G. Nie, H. Wu, N. Zhang, Z. Meng, and Z. Feng, “Spectrum sharing towards delay deterministic wireless network: Delay performance analysis,” IEEE Transactions on Cognitive Communications and Networking, DOI 10.1109/TCCN.2023.3270454, pp. 1-1, 2023.
[46] Z. Chen, K.-C. Chen, C. Dong, and Z. Nie, “6g mobile communications for multi-robot smart factory,” Journal of ICT Standardization, vol. 9, no. 1, pp. 371-404, 2021.

What is claimed:

1. A non-transitory computer readable medium having instructions stored thereon, wherein execution of the instructions by a processor of an equipment of a decentralized, autonomous multi-robot system comprising a plurality of robots and edge nodes causes the processor to:
execute control software for a decentralized, autonomous multi-robot system for on-demand production, the system having adaptive and resilience productivity and resource efficiency, each system comprising:
a blockchain module comprising smart contracts as a unified automation framework; and
a Merkle tree-based key management module for privacy preservation, wherein the key management ensures information exchange in the system is encrypted prior to data exchange and decryption requiring the joint effort of recipients.

2. The non-transitory computer readable medium of claim 1, wherein the on-demand production employ a machine learning model trained using Federated Learning (FL) for adaptive production.

3. The non-transitory computer readable medium of claim 1, wherein execution of the instructions by the processor of the equipment causes the processor to:
execute the Merkle tree-based key management module and the blockchain module;
encrypt control or communication data to be shared with a plurality of robots and associated edge nodes as an encrypted message using a key;
generate, via a hashing operation, (i) a complete key hash as a hash of the key and (ii) a Merkle tree having nodes comprising a plurality of partial key hashes split from the complete key hash;
add and transmit, via the blockchain module, as new block of a blockchain, the encrypted message and the complete key hash, wherein the blockchain is distributed to the plurality of robots or associated edge nodes; and
transmit (i) the Merkle tree, (ii) a partial key hash of the plurality of partial key hashes, and (iii) a partial key of the plurality of partial keys to each respective node of the plurality of robots or associated edge nodes,
wherein each respective node of the plurality of robots or associated edge nodes is configured to (i) receive the transmitted partial key hash as a first local partial key hash and received the partial key, (ii) transmit the first local partial key hash and received partial key to a paired node among the plurality of robots or associated edge nodes, (ii) receive, at least, a second local partial key hash corresponding to the paired node from the paired node and a corresponding partial key of the second local partial key hash, (iii) construct a local complete key hash from the first local partial key hash and, at least, the second local partial key hash, (iv) validate the new block in the blockchain via a smart contract operation of the blockchain if the constructed key hash matches the complete key hash in the new block, and (v) decrypt the control or communication data from the encrypted message using a key generated from (i) the Merkle tree, (ii) the received partial key of the first local partial key hash and, at least, (iii) the received partial key of the second local partial key hash.

4. The non-transitory computer readable medium of claim 1, wherein execution of the instructions by the processor of the equipment causes the processor to:
execute the Merkle tree-based key management module and the blockchain module;
receive, via the blockchain module, a blockchain having a new block comprising an encrypted message and a complete key hash for a message having control or the communication data, wherein the blockchain was distributed to a plurality of robots and associated edge nodes;
receive, from a delegated device corresponding to one of the plurality of robots and associated edge nodes, (i) a Merkle tree having nodes comprising a plurality of partial key hashes split from the complete key hash, (ii) a partial key hash of the plurality of partial key hashes, and (iii) a partial key of the plurality of partial keys,
receive, at least, from paired node, (i) a second local partial key hash corresponding to the paired node and (ii) a corresponding partial key of the second local partial key hash;
construct a local complete key hash from the first local partial key hash and, at least, the second local partial key hash;
validate the new block in the blockchain via a smart contract operation of the blockchain if the constructed key hash matches the complete key hash in the new block; and
decrypt the control or communication data from the encrypted message using a key generated from (i) the Merkle tree, (ii) the received partial key of the first local partial key hash and, at least, (iii) the received partial key of the second local partial key hash.

5. The non-transitory computer readable medium of claim 1, wherein execution of the instructions by the processor of the equipment causes the processor to:
execute the Merkle tree-based key management module and the blockchain module;
encrypt control or communication data to be shared with a plurality of robots and associated edge nodes as an encrypted message using a key;
generate, via a hashing operation, (i) a complete key hash as a hash of the key and (ii) a Merkle tree having nodes comprising a plurality of partial key hashes split from the complete key hash;
add and transmit, via the blockchain module, as new block of a blockchain, the encrypted message and the complete key hash, wherein the blockchain is distributed to the plurality of robots or associated edge nodes;
transmit (i) the Merkle tree, (ii) a partial key hash of the plurality of partial key hashes, and (iii) a partial key of the plurality of partial keys to each respective node of the plurality of robots or associated edge nodes, and
transmit a randomized key part-leaf node association;
wherein each respective node of the plurality of robots or associated edge nodes is configured to (i) receive the transmitted partial key hash as a first local partial key hash and received the partial key, (ii) receive the randomized key part-leaf node association; (iii) transmit the first local partial key hash and received partial key to a paired node among the plurality of robots or associated edge nodes, (iv) receive, at least, a second local partial key hash corresponding to the paired node from the paired node and a corresponding partial key of the second local partial key hash, (v) construct a local complete key hash from the first local partial key hash and, at least, the second local partial key hash, (vi) validate the new block in the blockchain via a smart contract operation of the blockchain if the constructed key hash matches the complete key hash in the new block, and (v) decrypt the control or communication data from the encrypted message using a key generated from (i) the Merkle tree, (ii) the received partial key of the first local partial key hash, (iii) the receive the randomized key part-leaf node association and, at least, (iv) the received partial key of the second local partial key hash.

6. The non-transitory computer readable medium of claim 1, wherein execution of the instructions by the processor of the equipment causes the processor to:
execute the Merkle tree-based key management module and the blockchain module;
receive, via the blockchain module, a blockchain having a new block comprising an encrypted message and a complete key hash for a message having control or the communication data, wherein the blockchain was distributed to a plurality of robots and associated edge nodes;
receive, from a delegated device corresponding to one of the plurality of robots and associated edge nodes, (i) a Merkle tree having nodes comprising a plurality of partial key hashes split from the complete key hash, (ii) a partial key hash of the plurality of partial key hashes, (iii) a randomized key part-leaf node association; and (iv) a partial key of the plurality of partial keys,
receive, at least, from paired node, (i) a second local partial key hash corresponding to the paired node and (ii) a corresponding partial key of the second local partial key hash;
construct a local complete key hash from the first local partial key hash and, at least, the second local partial key hash;
validate the new block in the blockchain via a smart contract operation of the blockchain if the constructed key hash matches the complete key hash in the new block;
decrypt the control or communication data from the encrypted message using a key generated from (i) the Merkle tree, (ii) the received partial key of the first local partial key hash, (iii) the received randomized key part-leaf node association, and, at least, (iv) the received partial key of the second local partial key hash.

7. The non-transitory computer readable medium of claim 3, wherein the decentralized, autonomous multi-robot system include an edge device configured to control or direct control the equipment and other equipment in a local network, and wherein the edge device is configured to (i) generate a Merkle tree, where the number of leaf nodes aligns with the number of recipients, (ii) encrypt the updated model, splits the key into parts, (iii) create a randomized key-part-to-leaf-node association, and (iv) transmits unique set of hashes per recipient along with the key parts and a hash-free Merkle tree topology.

8. The non-transitory computer readable medium of claim 3, wherein the equipment serves as an edge node in the decentralized, autonomous multi-robot system, wherein the equipment is configured to control or direct control the equipment and other equipment in a local network, and wherein the edge device is configured to (i) generate a Merkle tree, where the number of leaf nodes aligns with the number of recipients, (ii) encrypt the updated model, splits the key into parts, (iii) create a randomized key-part-to-leaf-node association, and (iv) transmits unique set of hashes per recipient along with the key parts and a hash-free Merkle tree topology.

9. The non-transitory computer readable medium of claim 3, wherein the equipment is configured to (i) encrypt local data, (ii) split a key of the local data into M parts, (iii) generate a Merkle tree MT with leaf nodes corresponding to number of parts and a randomized key part-leaf node association, and (iv) transmits the key part-leaf node association to the remaining N−1 robot nodes and the Merkle tree topology to all M edge nodes,
wherein all robot nodes transmit the key parts following the received key part leaf node association to all M edge nodes.

10. The non-transitory computer readable medium of claim 3, wherein the decentralized, autonomous multi-robot system is heterogenous, wherein the equipment is a first robot of a first type, peer equipment is a second robot of a second type, wherein the first type is the same as the second type.

11. The non-transitory computer readable medium of claim 3, wherein the decentralized, autonomous multi-robot system is non-heterogenous, wherein the equipment is a first robot of a first type, peer equipment is a second robot of a second type, wherein the first type is different from the second type.

12. The non-transitory computer readable medium of claim 3, wherein the control or communication data is associated with (i) a machine learning model employed in control or production of the equipment, (ii) a production schedule, (iii) demand forecast, or (iv) task assignment associated with operation of the equipment.

13. The non-transitory computer readable medium of claim 3, wherein execution of the instructions by the processor cause the processor to:
train an AI model to be employed in the equipment in the execution of the task;
wherein the training is performed by federated learning, wherein the federated learning as a decentralized privacy-preserving operation robots in different spatial locations to simultaneously and collaboratively learn from local data without actually exchanging the local data.

14. The non-transitory computer readable medium of claim 13, wherein execution of the instructions by the processor cause the processor to:
train an AI model to be employed in the equipment in the execution of the task, wherein the training is performed in a one-to-multiple manner for global model distribution, and wherein the key management follows a one-to-multiple key-sharing procedure.

15. The non-transitory computer readable medium of claim 14, wherein execution of the instructions by the processor cause the processor to:
train an AI model to be employed in the equipment in the execution of the task, wherein the training is performed in a multiple-to-multiple manner for local model uploading, wherein N nodes upload its respective model to M edge nodes followed by initialization by a delegated robot node.

16. The non-transitory computer readable medium of claim 3, wherein the consensus operation employed a Delegated Proof of Work operation.

17. The non-transitory computer readable medium of claim 3, the instructions to adjust the parameter of the one or more task parameters provides for real-time adjustment of temporal collaboration, production flows, and/or task execution parameters for the decentralized, autonomous multi-robot system.

18. The non-transitory computer readable medium of claim 3, wherein the decentralized, autonomous multi-robot system comprises a manufacturing robot, a warehouse sorting robot, or autonomous agent executing on a computing device.

19. A system comprising:
a processor; and
a memory having instructions stored thereon, wherein execution of the instructions causes the processor to:
execute control software for a decentralized, autonomous multi-robot system for on-demand production, the system having adaptive and resilience productivity and resource efficiency, each system comprising:
a blockchain module comprising smart contracts as a unified automation framework; and
a Merkle tree-based key management module for privacy preservation, wherein the key management ensures information exchange in the system is encrypted prior to data exchange and decryption requiring the joint effort of recipients.

20. A method comprising:
executing control software for a decentralized, autonomous multi-robot system for on-demand production, the system having adaptive and resilience productivity and resource efficiency, each system comprising:
a blockchain module comprising smart contracts as a unified automation framework; and
a Merkle tree-based key management module for privacy preservation, wherein the key management ensures information exchange in the system is encrypted prior to data exchange and decryption requiring the joint effort of recipients.
